(19) United States
(12) Patent Application Publication
(10) Pub. No.: US 2009/0167192 A1
(43) Pub. Date: Jul. 2, 2009

(54) ACTIVE FRAME SYSTEM FOR AMBIENT LIGHTING USING A VIDEO DISPLAY AS A SIGNAL SOURCE

(75) Inventors: Elmo M. A. Diederiks, Eindhoven (NL); Mark J. Elting, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,288

(22) PCT Filed: Jun. 27, 2005
(86) PCT No.: PCT/IB05/52125

§ 371 Date: Dec. 26, 2006

Related U.S. Application Data
(60) Provisional application No. 60/584,200, filed on Jun. 30, 2004.
(60) Provisional application No. 60/636,543, filed on Dec. 17, 2004.

(51) Int. Cl. G02F 1/00; H05B 37/02

(52) U.S. Cl. 315/149

(57) ABSTRACT

Active diffuser frame system (A) for a video display (D) provides ambient lighting in viewer object mode and relies on real-time video input only, with no separate lighting script required. The system uses a controllable light source, and multiple inputs to improve realism and fidelity. Video inputs include actual display light; sensing of display light; and the video display signal. The frame can include a light modulator, or a goniophotometric or goniochromatic element to change character (intensity, color) of ambient light as a function of viewing angles, or a photoluminescent emitter for new chromaticities outside the display color gamut. The frame can split light between the viewer and the frame input, and can derive an added video signal to drive selected display pixels to boost output of display light into the frame.

This invention relates to video displays and the production of ambient lighting effects therefrom. More particularly, it relates to an active diffuser frame system for using video display light and/or display video signals as a light, signal, or content source to control and produce lighting effects for ambient distribution, including spatial and calorimetric transformation of the display light to produce effects not capable of being provided by a conventional video display unit or light-transmissive device.

Engineers have long sought to broaden the sensory experience obtained consuming video content, such as by enlarging viewing screens and projection areas, modulating sound for realistic 3-dimensional effects, and enhancing video images, including broader video color gamuts, resolution, and picture aspect ratios, such as with high definition (HD) digital TV television and video systems. Moreover, film, TV, and video producers also try to influence the experience of the viewer using visual and auditory means, such as by clever use of color, scene cuts, viewing angles, peripheral scenery, and computer-assisted graphical representations. This would include theatrical stage lighting as well. Lighting effects, for example, are usually scripted—synchronized with video or play scenes—and reproduced with the aid of a machine or computer programmed with the appropriate scene scripts encoded with the desired schemes. Automatic adaptation of lighting to fast changes in a scene, particularly unplanned or unscripted scenes, is not usually possible.

Philips (Netherlands) and other companies have disclosed means for changing ambient or peripheral lighting to enhance video content for typical home or business applications, but this typically involves using separate light sources far from the video display, and for many applications, some sort of advance scripting or encoding of the desired lighting effects. Ambient lighting added to a video display or television has been shown to reduce viewer fatigue and improve realism and depth of experience. The creation of ambient lighting in the immediate vicinity of the display output, however, has proved problematic in practice.

This invention uses captured video display light or video display signals from a video display unit itself to produce light atmospheres and effects, using an active frame or active diffuser frame system. The video display unit can use any technology or platform, such as CRT (Cathode Ray Tube); LCD (Liquid Crystal Display); PDP (Plasma Display Panel); FED (Field Emission Display) or other technologies. It is even applicable, for many embodiments, to any transmissive medium for the delivery of video or visual information, such as found in a window of a building. For clarity of discussion, video displays shall be used here for illustrative purposes.

Sensory experiences are naturally a function of aspects of human vision, which uses an enormously complex sensory and neural apparatus to produce sensations of color and light effects. Humans can distinguish perhaps 10 million distinct colors. In the human eye, for color-receiving or photopic vision, there are three sets of approximately 2 million sensory bodies called cones which have absorption distributions which peak at 445, 535, and 565 nm light wavelengths, with a great deal of overlap. These three cone types form what is called a tristimulus system and are called B (blue), G (green), and R (red) for historical reasons; the peaks do not necessarily correspond with those of any primary colors used in a display, e.g., commonly used RGB phosphors. There is also interaction for scotopic, or so-called night vision bodies called rods. The human eye typically has 120 million rods, which influence video experiences, especially for low light conditions such as found in a home theatre.

Color video is founded upon the principles of human vision, and well known trichromatic and opponent channel theories of human vision have been incorporated into our understanding of how to influence the eye to see desired colors and effects which have high fidelity to an original or intended image. In most color models and spaces, three dimensions or coordinates are used to describe human visual experience.

Color video relies absolutely on metamerism, which allows production of color perception using a small number of reference stimuli, rather than actual light of the desired color and character. In this way, a whole gamut of colors is reproduced in the human mind using a limited number of reference stimuli, such as well known RGB (red, green, blue) tristimulus systems used in video reproduction worldwide. It is well known, for example, that nearly all video displays show yellow scene light by producing approximately equal amounts of red and green light in each pixel or picture element. The pixels are small in relation to the solid angle they subtend, and the eye is fooled into perceiving yellow; it does not perceive the green or red that is actually being broadcast.

There exist many color models and ways of specifying colors, including well known CIE (Commission Internationale de l'Eclairage) color coordinate systems in use to describe and specify color for video reproduction. Nothing in this disclosure precludes use of displays or color spaces using distimuli or quadrastimuli systems, or systems producing many reference stimuli. Any number of color models can be employed using the instant invention, including application to opponent color spaces, such as the CIE L*U*V* (CIELUV) or CIE L*a*b* (CIELAB) systems. The CIE established in 1931 a foundation for all color management and reproduction, and the result is a chromaticity diagram which uses three coordinates, x, y, and z. A plot of this three dimensional system at maximum luminosity is universally used to describe color in terms of x and y, and this plot, called the 1931 x,y chromaticity diagram, is believed to be able to describe all perceived color in humans. This is in contrast to color reproduction, where metamerism is used to fool the eye and brain. Many color models or spaces are in use today for reproducing color by using three primary colors or phosphors, among them ISO RGB, Adobe RGB, NTSC RGB, etc.

It is important to note, however, that the range of all possible colors exhibited by video systems using these tristimulus systems is limited. The NTSC (National Television Standards Committee) RGB system has a relatively wide range of colors available, but this system can only reproduce half of all colors perceivable by humans. Many blues and violets, blue-greens, and oranges/reds are not rendered adequately using the available scope of traditional video systems.

Furthermore, the human visual system is endowed with qualities of compensation and discernment whose understanding is necessary to design any video system. Color in humans can occur in several modes of appearance, among them, object mode and illuminant mode.

In object mode, the light stimulus is perceived as light reflected from an object illuminated by a light source. In illuminant mode, the light stimulus is seen as a source of light. Illuminant mode includes stimuli in a complex field that are much brighter than other stimuli. It does not include stimuli known to be light sources, such as video displays, whose brightness or luminance is at or below the overall brightness of the scene or field of view so that the stimuli appear to be in object mode.

Remarkably, there are many colors which appear only in object mode, among them, brown, olive, maroon, grey, and beige flesh tone. There is no such thing, for example, as a brown illuminant source of light, such as a brown-colored traffic light.

For this reason, supplements to video systems which attempt to add object colors cannot do so using direct sources of light. No combination of bright red and green LEDs (light emitting diodes) at close range can reproduce brown or maroon, and this limits choices considerably. Only spectral colors of the rainbow, in varying intensities and saturation, can be reproduced by direct observation of bright sources of light.

The active diffuser frame system of the invention relies on video input only, with no script or additional communications for ambient light coding required, and can make use of multiple inputs from video to improve realism and fidelity to the video image.

Prior art systems that attempt to introduce light into an ambient space often require a separate information channel for system operation, such as the separate entertainment control signal needed in the lighting entertainment system disclosed in U.S. Pat. No. 6,166,496 to Lys et al., or the computer code or computer application content needed to operate ambient lighting as disclosed by Dowling et al. in US Publication No. US 2003/0057884. Virtually no existing video broadcast systems place ambient lighting code or instructions in any analog waveform spaces, such as the vertical blanking interval in the NTSC broadcast system, and virtually no digital image systems (e.g., DVD formats, MPEG4, etc.) or place ambient lighting code in any in any subcode, such as DVD subcode or composite digital video ancillary spaces.

Another disadvantage of many prior art ambient lighting systems is that the light sources used are not capable of displaying video information in object mode, and thus huge expanses in human color space are not producible by them.

Another disadvantage is that current descriptions of ambient lighting that is placed proximate to the video delivery device or display tragically causes a lost opportunity for exploiting known characteristics of the human visual system. One possible reason for avoiding ambient lighting that competes closely in terms of close physical proximity to a video display unit using active light sources is that the image produced is often garish, inappropriate, and not subtle.

Often, prior art light sources and methods for driving them to produce ambient light are a poor match for the quality and nuances of the video display. In other cases, one relies on derivation of a virtual image space of sorts to create essentially another supplemental video display for ambient light production—such as found in U.S. Pat. No. 6,611,297 to Akashi et al. where although it is suggested that a frame around a display can be used in pseudo light emitting or object mode, separately derived illumination control data is required and no teaching is given to provide a pleasing and realistic output whose available color space is a match for the display itself—or beyond that of the display—using an inexpensive system that does not require creation of a virtual image space embodied in separately recorded illumination control data or does not require what amounts to a supplemental video display.

It is therefore advantageous to not have to undertake the creation of a virtual image space that essentially creates a second display to be used as a light frame and not to require separately derived illumination control data, but rather to depend only on data directly available from the video display unit. It is also advantageous to exceed the available gamut of colors available to traditional light sources and to expand the possible gamut of colors reproduced by a typical tristimulus video display system. It is also desired to exploit characteristics of the human eye, such as changes in relative luminosity of different colors as a function of light levels, by modulating or changing color delivered to the video user using an active diffuser frame system that uses to good advantage compensating effects, sensitivities, and other peculiarities of human vision that are best exploited in a frame that surrounds the display, or provides ambient light in close association with a video display. It is also desirable to make such a system backwardly compatible with existing broadcast and productions standards like NTSC, SECAM, PAL, and MPEG4.

Concerning light capture discussed below, prior art frames that surround video screens do not function in the way the present invention does to capture, redirect, and broadcast light as taught here. In contrast to many prior art designs, this invention does not get involved with side light inside a display, such as a traditional CRT. This invention optionally captures light from the front display face only, in contrast, for example, to U.S. Pat. No. 2,837,734 to R. M. Bowie, Surround-Lighting Structure, where CRT side light from a band of transparent glass 22 is captured by a planar transparent member 30.

Information about human vision, color science and perception, color spaces, colorimetry and image rendering, including video reproduction, can be found in the following references which are hereby incorporated into this disclosure in their entirety: ref[1] Color Perception, Alan R. Robertson, Physics Today, December 1992, Vol 45, No 12, pp. 24-29; ref[2] The Physics and Chemistry of Color, 2ed, Kurt Nassau, John Wiley & Sons, Inc., New York© 2001; ref[3] Principles of Color Technology, 3ed, Roy S. Berns, John Wiley & Sons, Inc., New York, © 2000; ref[4] Standard Handbook of Video and Television Engineering, 4ed, Jerry Whitaker and K. Blair Benson, McGraw-Hill, New York© 2003.

The invention relates to a apparatus and method for an active diffuser frame system for a video display unit that provides high realism and freedom to create desired (and new) chromaticities and effects without having to create another virtual image space, such as separately derived and recorded illumination control data to be used to drive another supplemental display.

The invention relates to an apparatus and method for an active diffuser frame system for a video display unit to broadcast ambient light into an ambient space, where the system uses any of a number of controllable light sources that sized, positioned, and optically formed as to direct output light from itself to produce ambient light. This light source, which can comprise many types of lighting devices or a lighting array, is formed and configured to allow control of the ambient light using at least an active diffuser frame input derived from the video display unit itself, to increase fidelity and realism. Three active frame inputs can be used, individually, or together in any combination:

[a] passive optical input of display output light from the video display unit;
[b] passive sensing of display output light from the video display unit, using a display light sensor; and [c] at least a portion of an active video signal that drives the video display unit. Display output light from the display can be mixed with light from the controllable light source. Output light generated through or inside the active diffuser frame is broadcast to the ambient space using a distributive outer frame or a frame light modulator to distribute the output light into the ambient space in viewer object mode.

This invention allows that native original display light from the video display can be used in the active frame system, such as to light or help light the distributive outer frame. In one embodiment, active intervention into the display itself is possible to boost this contribution from the display by using of the latter two active frame inputs to drive selected output pixels of the video display using a processor to generate a generate a fiducial area video signal provided to the video display unit. This drives fiducial output pixels in the video display unit that reside in a fiducial area to produce modified display light used directly by the frame, and possibly mixed with light from the controllable light source.

The invention can further comprise a room condition sensor to sense ambient conditions in an ambient space about the video display unit, such as a room light sensor, a room sound sensor, and a frame touch sensor, to allow sensing of room conditions and user preference input to exploit cleverly certain characteristics of human vision and toggle or choose between active frame output modes, such as flamboyant or subdued.

The distributive outer frame can be an optical device or devices such as a optical diffuser, a frame light modulator, and a photoluminescent emitter.

The processor can gather and store user preferences to influence control of the ambient light, and provide a graphical user interface upon an exterior surface of the active diffuser frame system to further record preferences and give system status. The processor can also control the light source so that a character of the ambient light is influenced by the active frame input, and can comprise a frame output memory to store and utilize a history of the active frame light control signal to further control the light source. This allows adjusting the ambient light produced by the active frame to account for recent scene light, such as a bright stimulus, so as to make the ambient light output more pleasurable and less conspicuous.

The light source can comprises a an LED (Light Emitting Diode), an electroluminescent device, an incandescent lamp, an ion discharge lamp, a laser, a FED (Field Emission Display), an LCD (Liquid Crystal Display) a frame light modulator, and a photoluminescent emitter and this can be combined with display output light obtained using a light guide.

This light guide can be formed to split, by reflection from a surface, some of the display output light from the video display unit in the active frame input to be redirected for use by the active frame, and other display output light to pass substantially outwardly to a viewer as imaging light, so the viewer still sees the whole image area on the display.

The active diffuser frame system can comprise a photoluminescent emitter to provide a spectral modification for the light source so as to color-transform the ambient light emitted from at least a portion of the active diffuser frame system. This photoluminescent emitter can be chosen such that the ambient light produced comprises at least one new color that is outside of a gamut of display output light colors inherently producible by the video display unit unaided by the active diffuser frame system.

Other embodiments include use of a goniophotometric element that allows the active frame to emit ambient light which is goniophotometric, that is, changing character as a function of an angle of observation (N, 2) of the active diffuser frame system, or specifically, goniochromatic, that is, changing color as a function of an angle of observation of the active diffuser frame system. The goniophotometric element can comprise a material such as: metal flakes, glass flakes, plastic flakes, particulate matter, oil, fish scale essence, thin flakes of guanine, 2-aminohypoxanthine, ground mica, ground glass, ground plastic, pearlescent material, bornite, and peacock ore.

Another embodiment gives an active diffuser frame system for a video display unit to broadcast ambient light into an ambient space, using a light guide in optical communication with display output light from the video display unit; and a frame light modulator in optical communication with the light guide, with the frame light modulator so formed and configured to influence a character of the ambient light using at least the display output light.

The invention includes a method for broadcasting ambient light into an ambient space about a video display unit from an active diffuser frame system, using an active frame input from the video display unit, comprising: [1] obtaining an active frame input derived from the video display unit, selected from [a] passive optical input of display output light from the video display unit, using a light guide sized, formed and positioned to allow optical communication with the video display unit so as to capture the display output light therefrom; [b] passive sensing of output light from the video display unit, using a display light sensor to transduce the output light from the video display unit for use by the active diffuser frame system, and [c] at least a portion of an active video signal that controls the video display unit; and [2] controlling the ambient light using the active frame input using a controllable light source sized, positioned, and optically formed as to direct output light from itself to become emitted ambient light, and [3] mixing the output light by passage through a distributive outer frame (AF) for distribution into the ambient space.

Other possible steps include color-transforming the ambient light by passing the output light from the light source to a photoluminescent emitter in at least a portion of the active diffuser frame system, and/or passing the output light from the light source through a goniophotometric element so formed and placed as to provide ambient light which is goniophotometric or goniochromatic.

The method can also include using a processor in command communication with the light source to influence the control of the ambient light based on any or all number of factors such as light intensity in the ambient space; sound in the ambient space; touch sensing in the active diffuser frame system; a history of operation of the active diffuser frame system, by storing and using the history in the processor using a memory; and a user preference held in a processor memory. The processor can also optionally, for certain embodiments, derive from the active frame input a fiducial area video signal and add information from this signal to the video signal controlling the video display unit so as to drive a plurality of fiducial output pixels in the video display unit that reside in a fiducial area that is used to pump actual display light into the active diffuser frame system.

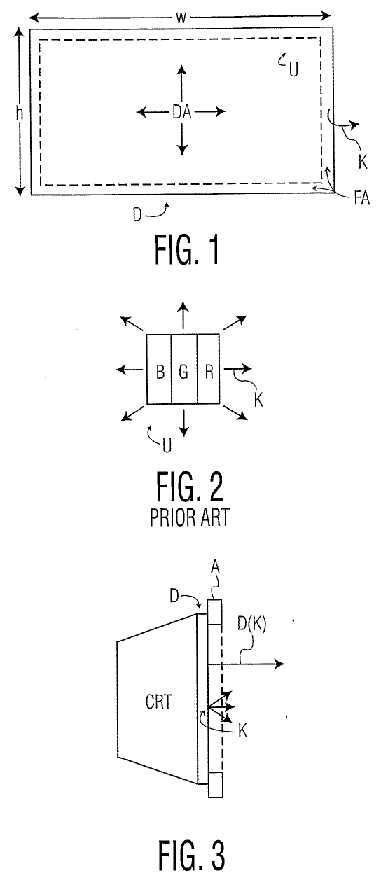

FIG. 1 shows a frontal surface view of a rectangular video display, with a fiduciary area applied to production of ambient light;

FIG. 2 shows a frontal schematic view of a prior art RGB video pixel in the display of FIG. 1;

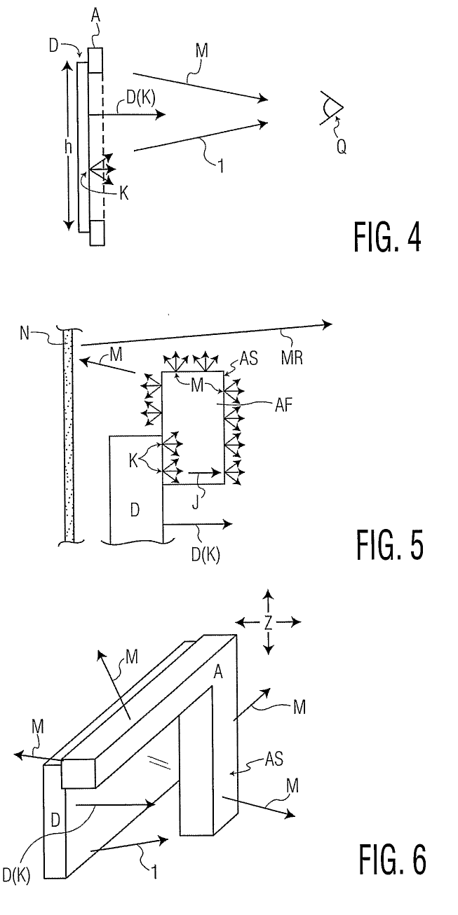

FIGS. 3 and 4 show a schematic cross-sectional side view of a cathode-ray tube display and a flat panel display, respectively, fitted with one active diffuser frame according to the invention;

FIG. 5 shows a close-up view of the upper portion of the schematic cross-section of FIG. 4, showing generalized light flows;

FIG. 6 shows an oblique schematic surface view of the upper right portion of a display, fitted with a generalized block active frame according to the invention;

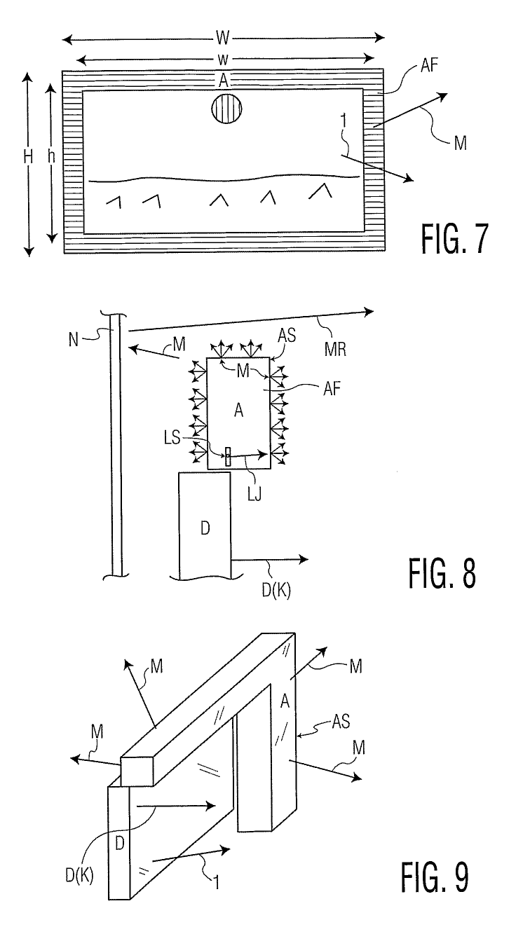

FIG. 7 shows a frontal schematic surface view of a display using an active frame to broadcast display scene light into an ambient environment;

FIG. 8 shows a close-up view similar to that of FIG. 5, but for a non-interceptive embodiment where the active frame does not intercept light from the video display unit;

FIG. 9 shows a view similar to that of FIG. 6, but showing a schematic surface view for the embodiment of FIG. 8;

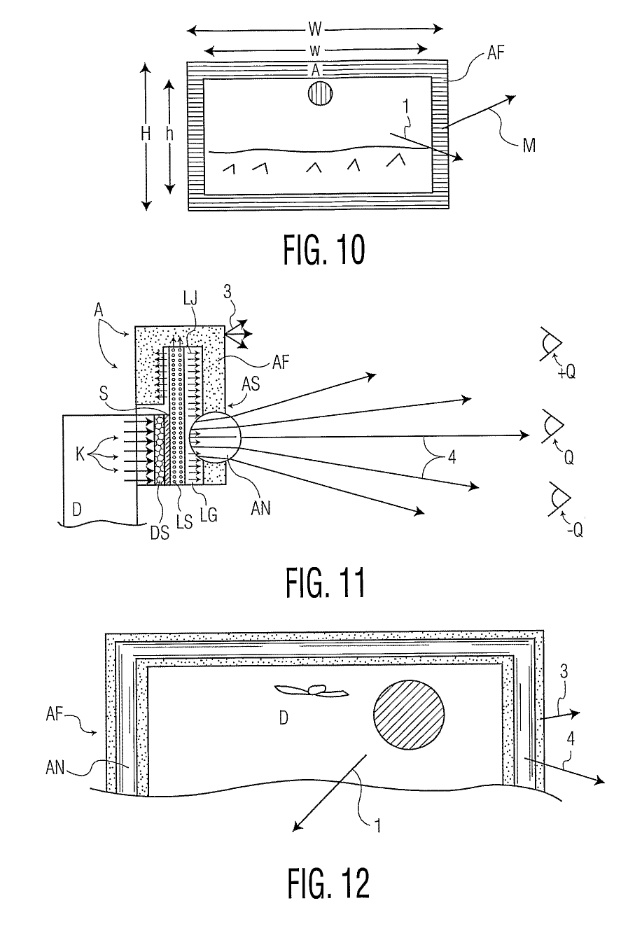

FIG. 10 shows a frontal schematic view similar to that of FIG. 7, but for the non-interceptive embodiment of FIGS. 8 and 9.

FIG. 11 shows a generalized schematic cross-sectional view of an upper portion of an active diffuser frame system according to the invention which uses an active frame input passive sensing of display output light from the video display unit using a display light sensor, and also comprising a goniophotometric element;

FIG. 12 shows a partial upper frontal surface view for the goniophotometric active diffuser frame embodiment shown in FIG. 10;

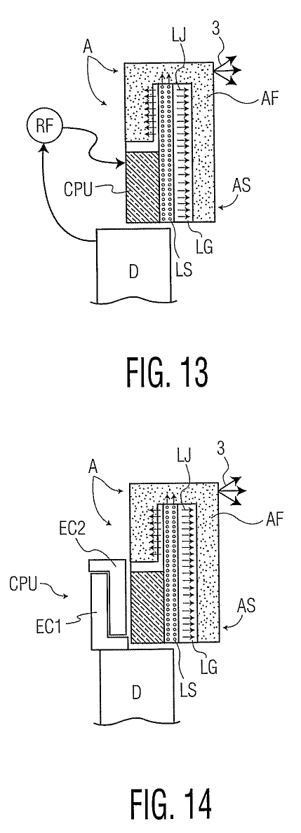

FIG. 13 shows a generalized schematic cross-sectional view of an upper portion of a non-interceptive active diffuser frame system according to the invention which utilizes an active video signal supplied to the video display unit to control a light source therein;

FIG. 14 shows a view similar to that of FIG. 13, but for another embodiment where the active diffuser frame system utilizes electromagnetic couplers for an active frame input of the active video signal delivered to the video display unit;

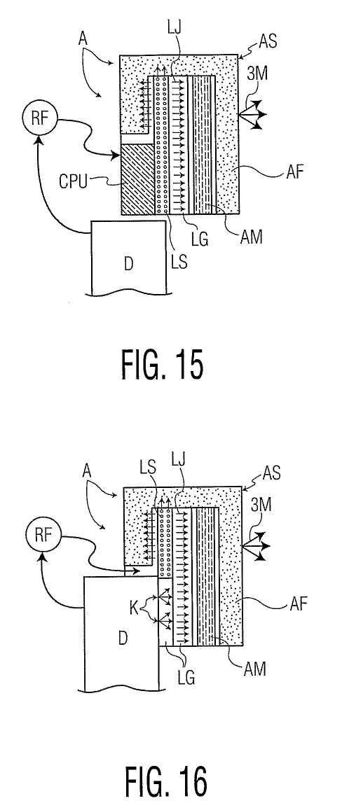

FIG. 15 shows a view similar to that of FIG. 13, but for another embodiment where the light source output is modulated by a light modulator;

FIG. 16 shows a view similar to that of FIG. 15, but for another embodiment using a partially interceptive configuration;

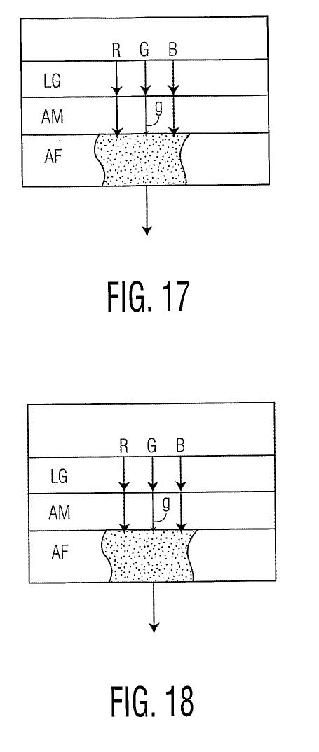

FIGS. 17 and 18 show basic schematic block diagrams for illustrative light flows in the embodiments shown in FIGS. 15 and 16, respectively, where light emitted by a light source and/or display passes through a light guide and is modulated to remove some green light, emerging after additive mixing to become magenta ambient light;

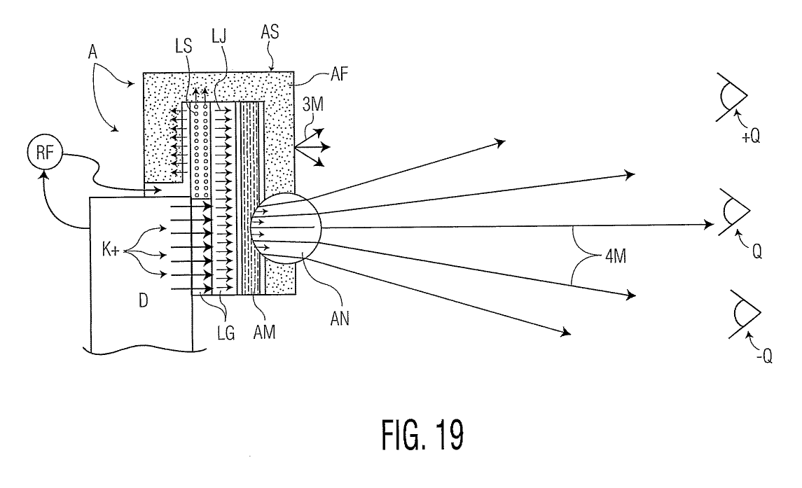

FIG. 19 shows a view similar to that of FIG. 16, but for another embodiment where the active diffuser frame system generates a fiducial area video signal to supplement the video signal provided to the video display unit to produce modified video display light, and also comprising a goniophotometric element;

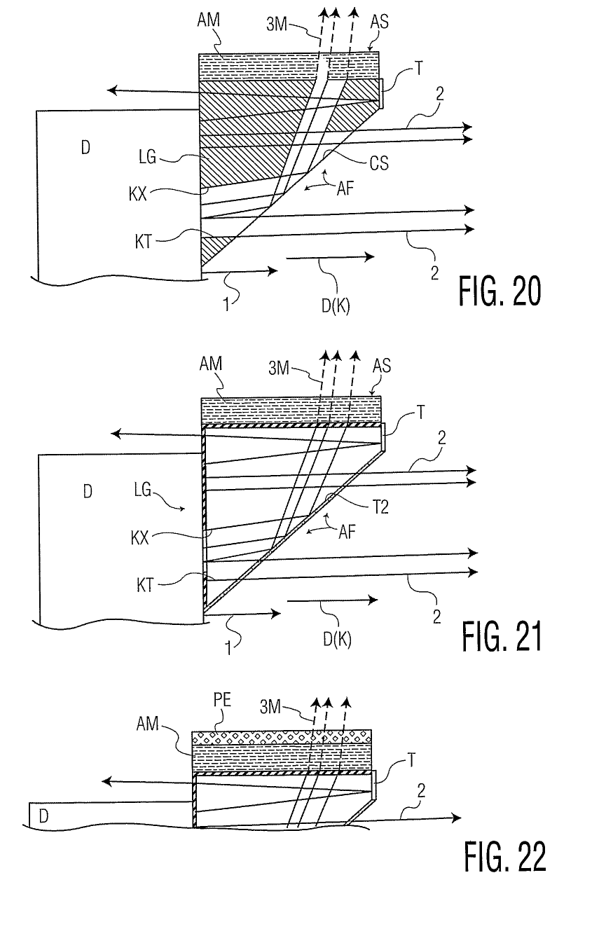

FIG. 20 shows a close-up cross-sectional view of the upper portion of a display fitted with a splitter-prism equipped active diffuser frame system according to another embodiment of the invention, comprising a light guide and distributive outer frame using partial internal reflection at a critical surface to redirect light for ambient distribution, also providing simultaneous forward transmission of light for enabling viewing of display image light, with schematic light rays shown, including frame image light, and where the light directed for ambient distribution passes through a frame light modulator;

FIG. 21 shows an another embodiment of the invention similar in function to that shown in FIG. 18, using a partial reflector in lieu of internal reflection at a critical surface, and using a frontal reflector to enhance back spill of ambient light;

FIG. 22 shows another embodiment of the invention similar in function to that shown in FIG. 21, specifically showing the upper portion thereof, and equipped with a photoluminescent emitter to further modify light before ambient release;

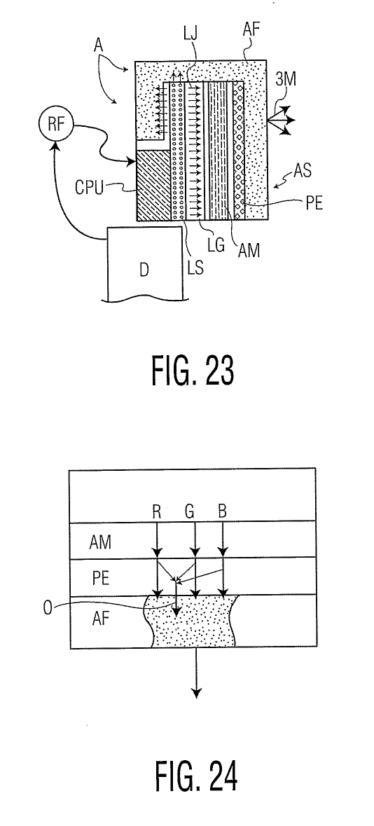

FIG. 23 shows another embodiment of the invention similar in function to that shown in FIG. 15, additionally comprising a photoluminescent emitter to further modify light before ambient release;

FIG. 24 shows a basic schematic block diagram for an illustrative light flow for the embodiment given in FIG. 23, whereby the active diffuser frame performs a color transformation using a photoluminescent emitter interposed between the frame light modulator and the distributive outer frame surface to produce ambient light having a new color not originally present in the original video image, using excitation and re-emission by a fluorescent pigment in the photoluminescent emitter;

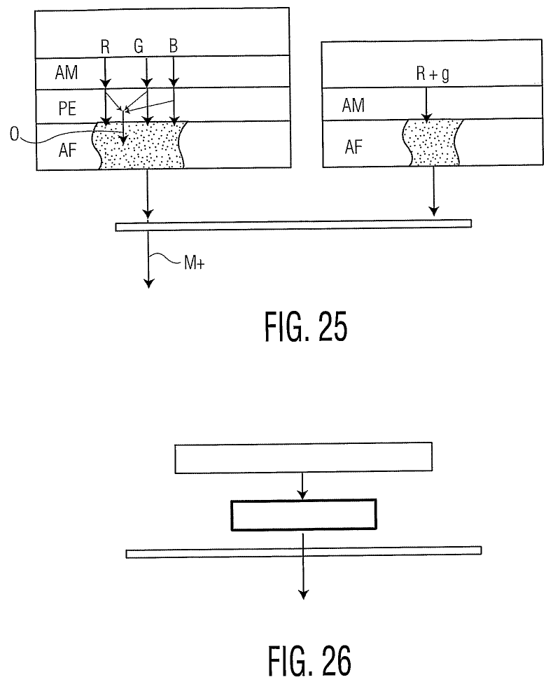

FIG. 25 shows a comparison between the color transformation process of FIG. 24 according to the invention with that of conventional video color production by the display, showing schematically an original video image using primaries R, G and B to produce a new orange color not inherently producible by the display, and compared to production of the nearest color chromaticity using light inherently produced by the display. The figure shows that the light produced by an active diffuser frame using a photoluminescent emitter according to the invention can exceed the MacAdam limit for that chromaticity;

FIG. 26 shows generally in a block schematic the process by which fluorescence can be used by the active diffuser frame of the invention to produce a color outside the gamut of colors ordinarily produced by the video display;

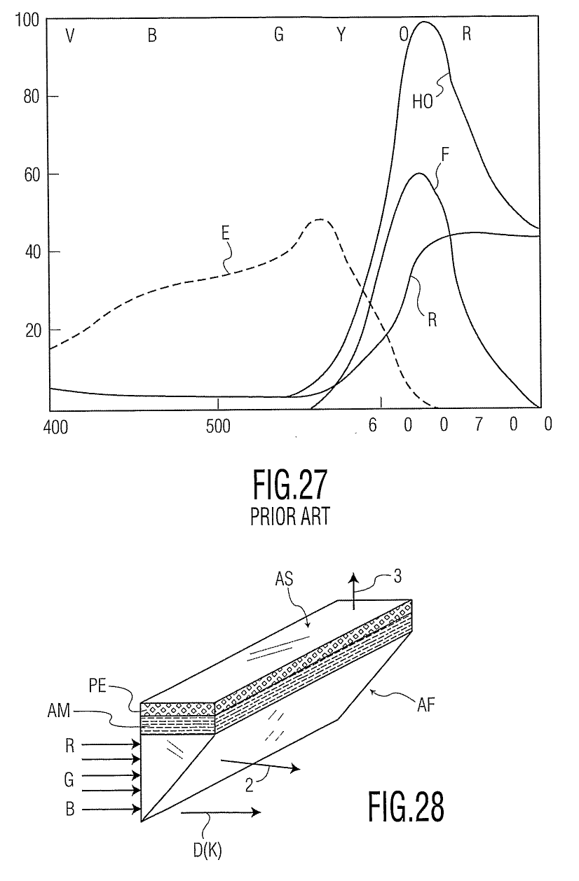

FIG. 27 shows a prior art plot of activation, reflection, fluorescence, and total output spectral distributions for a typical fluorescent material that might be used for the embodiments illustrated by FIGS. 22-26;

FIG. 28 shows a cross-sectional oblique view of a simple splitter prism active diffuser frame element for an active diffuser frame system comprising a frame light modulator and a photoluminescent emitter for conditioning light source output light before ambient release;

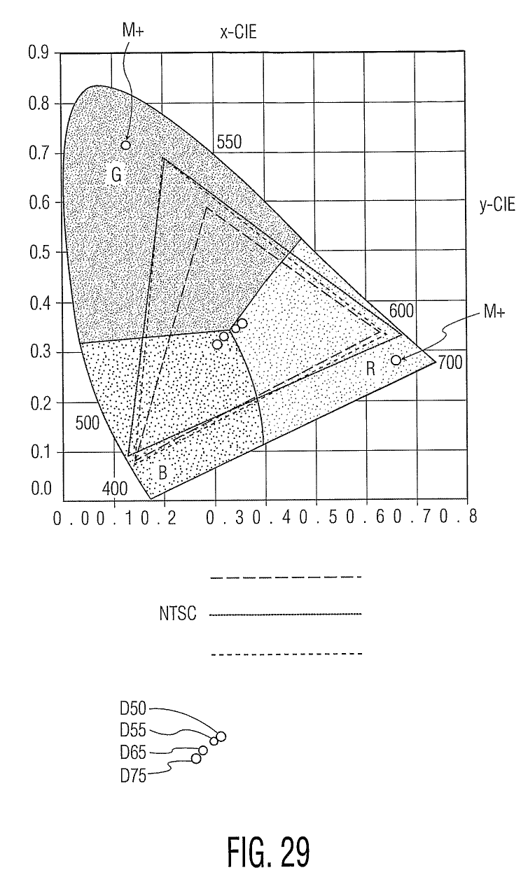

FIG. 29 shows two possible colors or chromaticity coordinates on a standard CIE color map which lie outside the gamut of colors obtainable by PAL/SECAM, NTSC, and Adobe RGB color production methods;

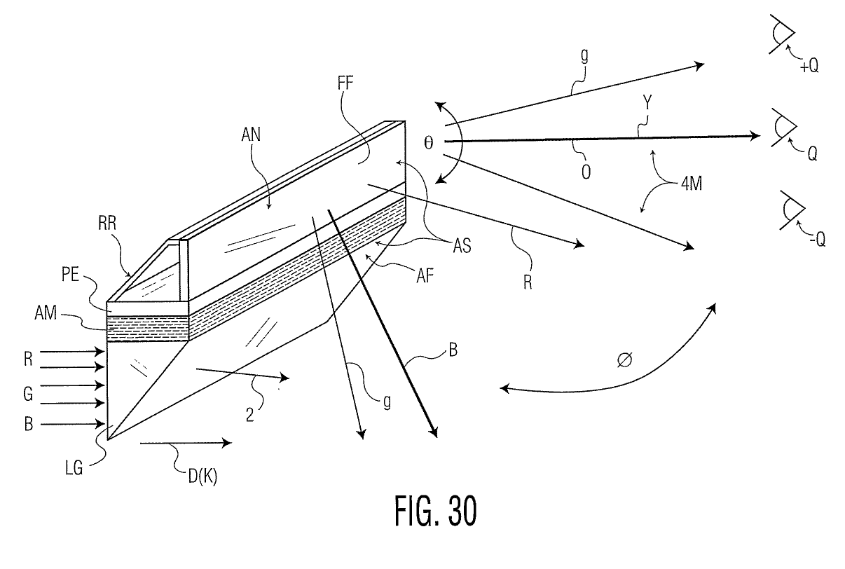

FIG. 30 shows another embodiment of the invention similar to that shown in FIG. 28 where the active diffuser frame additionally comprises a goniochromatic element to produce different light colors, intensity, and character as a function of viewing angles Theta and Phi. The active diffuser frame is shown as an oblique cross-section comprising a light guide in optical communication with a goniochromatic element, a photoluminescent emitter and a frame light modulator;

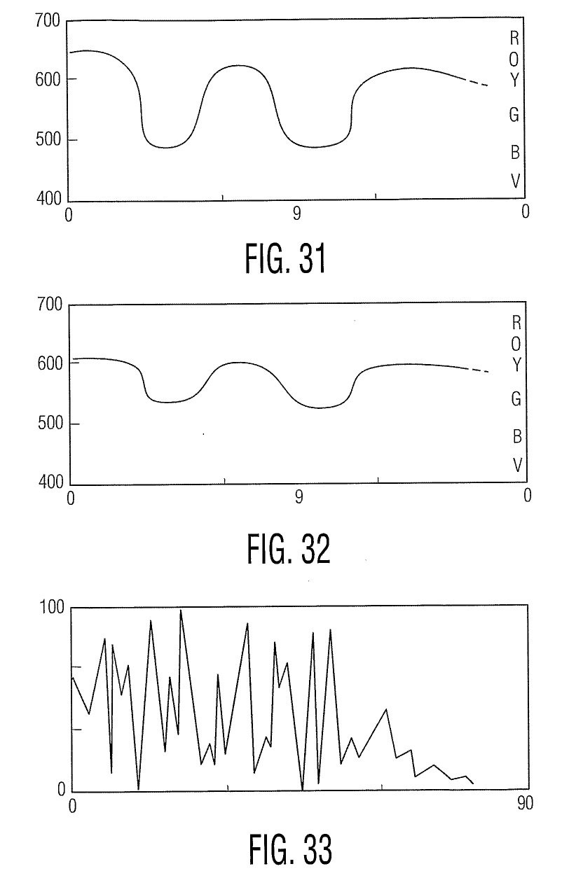

FIGS. 31 and 32 show Cartesian plots of dominant color wavelength of ambient light produced versus viewing angles Phi and Theta, respectively, for the goniochromatic embodiment illustrated in FIG. 30;

FIG. 33 shows a Cartesian plot of relative light intensity of ambient light produced versus viewing angle Phi, for the goniochromatic embodiment illustrated in FIG. 30;

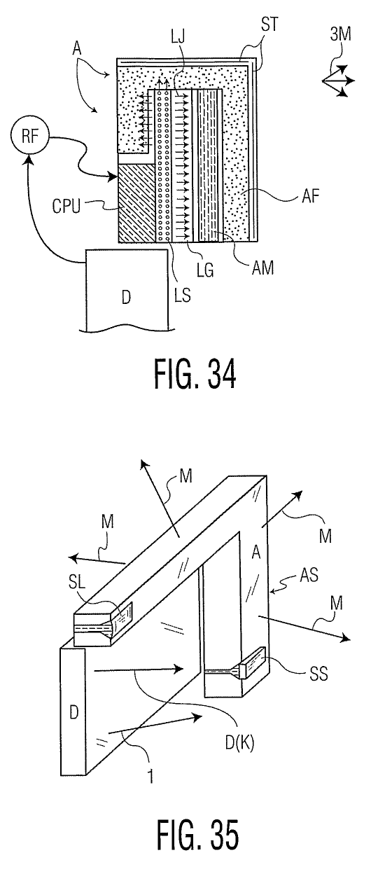

FIG. 34 shows another embodiment of the invention, similar to that shown in FIG. 15, additionally comprising a frame touch sensor on an outer surface of the distributive outer frame;

FIG. 35 shows an embodiment similar to that shown in FIG. 9, but additionally comprising a light sensor, and a sound sensor;

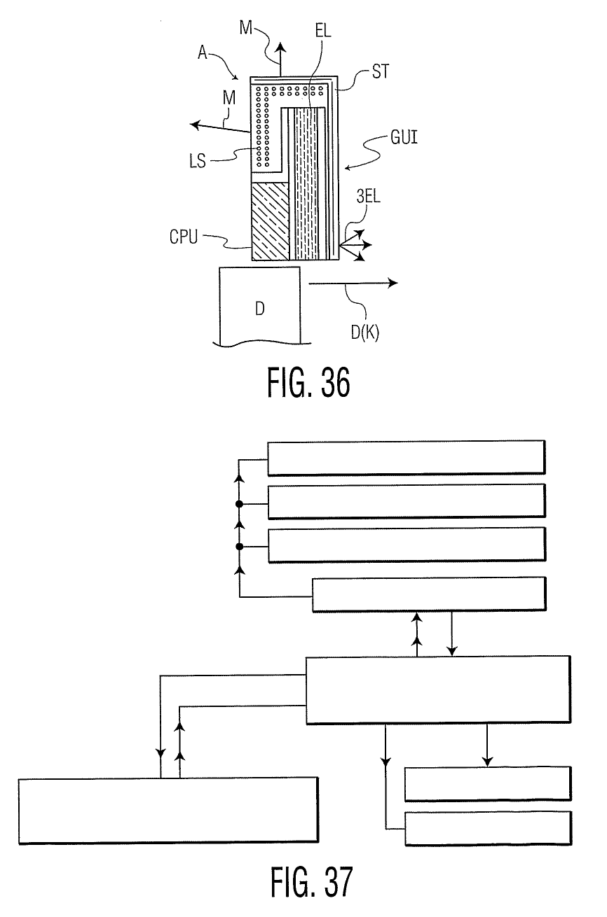

FIG. 36 shows a close-up schematic cross-sectional view of the upper portion of another embodiment of an active diffuser frame system according to the invention whereby multiple light sources are used, including an electroluminescent display that provides a graphical user interface;

FIG. 37 shows a functional schematic diagram for control of an active diffuser frame system according to the invention including video content analysis used to influence operation of any of a number of light sources;

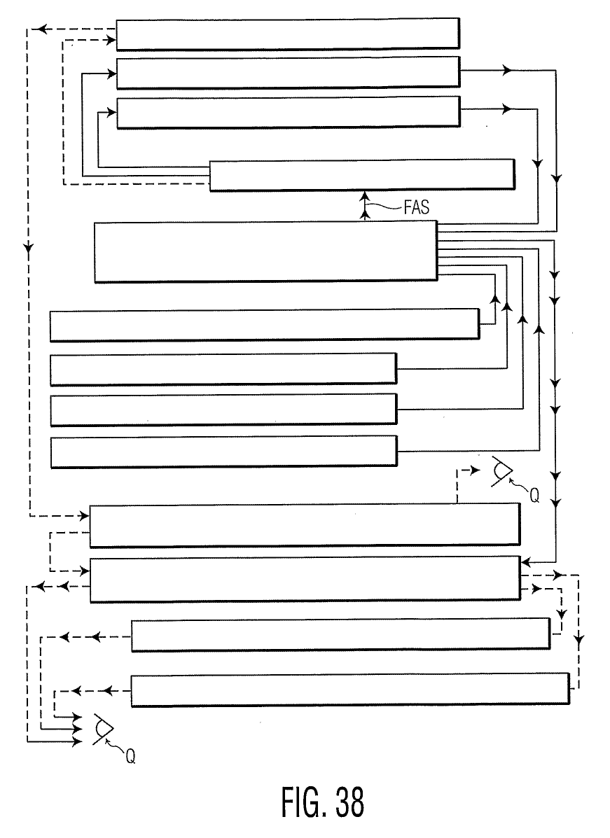

FIG. 38 shows a functional schematic diagram for control of an active diffuser frame system according to the invention including using a plurality of active frame inputs, and where ambient conditions and user preferences are utilized;

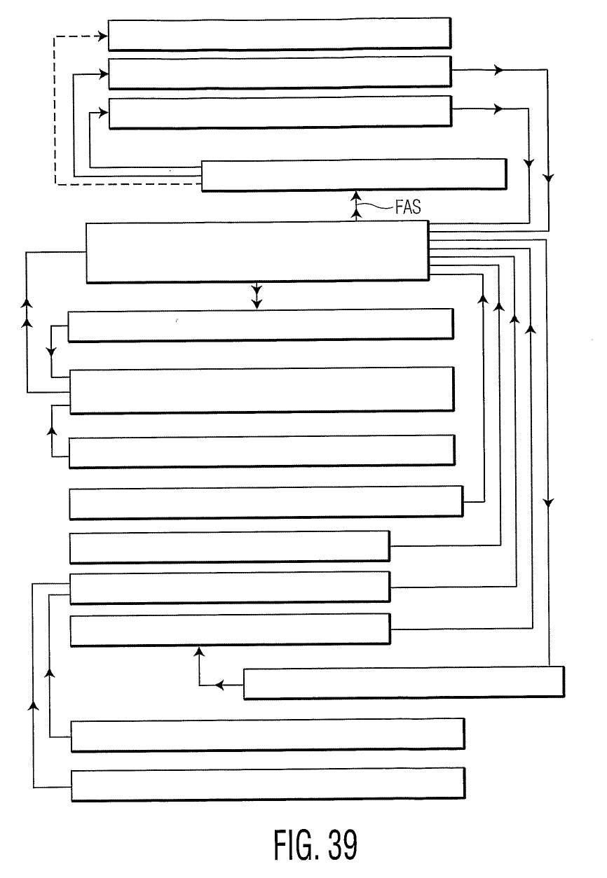

FIG. 39 shows a functional schematic diagram for control of an active diffuser frame system according to the invention, including video frame parsing and use of a graphical user interface;

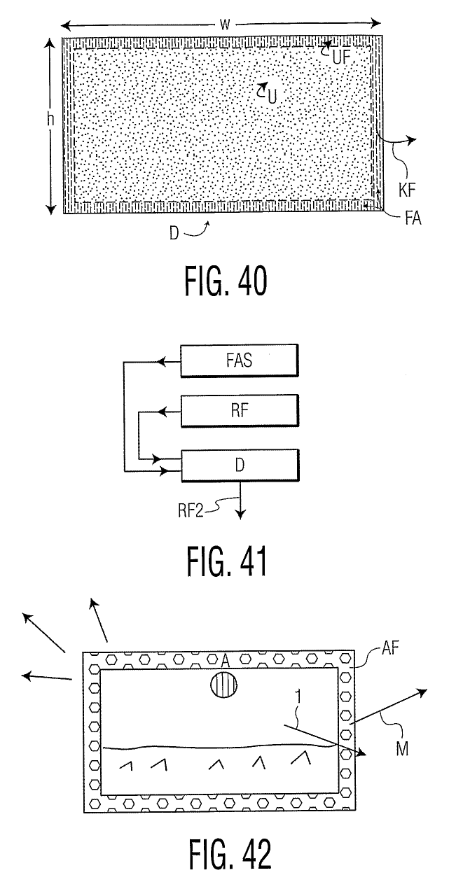

FIG. 40 shows a video display unit similar to that shown in FIG. 1, but where a fiducial area video signal is provided to the video display unit to drive output pixels that reside in a fiducial area to produce modified display light;

FIG. 41 shows a general schematic showing combining of video frame information to incorporate the original video signal with a fiducial area video signal to drive selected pixels in the video display unit;

FIG. 42 shows a frontal schematic surface view of a display using an active frame similar to that shown in FIG. 10, where the active frame ambient light shows a broadcast pattern which can flunctuate and appear to move as a function of time, and in response to video content;

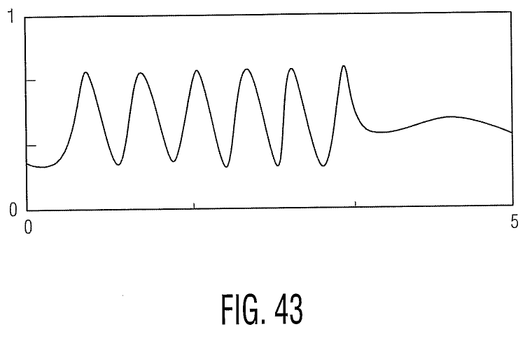

FIG. 43 shows a cartesian plot of relative luminous intensity versus time for an active diffuser frame system which modulates a localized or general output for itself in response to video content analysis, including any constituent audio portion of the video content.

### The Following Definitions Shall be Used Throughout:

Active Diffuser Frame—shall connote any light-broadcasting structure surrounding, adjacent to, or sharing an ambient space with a video display or the equivalent, and comprising a controllable light source to emit ambient light whose character is derived in some way from, or influenced by video content that is delivered to, emitted by, or meant for the video display. An active diffuser frame system, or the ambient light which it emits, will typically be formed, sized, and positioned to lie within the foveal view of an observer when the when the center of vision is fixated upon any portion or edge of the display.

Ambient Light—shall connote light that is surrounding, encircling, or being emitted about or near a video display, such as emanating from an active frame or spilled onto a wall or generally outward behind the display. This is in contrast to light which is outwardly emitted by a display by its inherent original design. It does not preclude the use of a supplementary display or displays which draw upon video content delivered to the video display and which provide ambient light not originally provided by the display.

Ambient space—shall connote any and all material bodies or air or space external to a video display unit.

Control—as in controlling a light source shall, in the appended claims, refer to controlling directly or indirectly the light source so that character of the output light made therefrom changes, such as by changing any of the hue, saturation, intensity, or other photometric quality, e.g., specular reflection properties, retroreflective properties, etc. This shall include controlling an on/off duty cycle for a plurality of light generating devices, changing the transmission characteristics of a frame light modulator, changing the luminous output of an electroluminescent device, adjusting the effectiveness of a goniophotometric element (e.g., changing the angle of a goniophotometric element such as front face FF of goniophotometric element AN in FIG. 30), or any other change which changes ambient light character as a function of an active frame input. With this definition, control shall not connote simply an on/off switch for a set of incandescent or other lamps placed about a video display unit, where the only control exerted is to turn the lamps on when viewing the video display. Control shall be interpreted in the context of the appended claims, where it is at least partly defined by utilizing an active frame input from the video display in the form of display output light that is directly obtained or sensed—or video content (e.g., video display signal RF) driving the video display.

Diffuse—shall denote that quality of light interaction which is non-image transmitting and typically somewhat or substantially isotropic in intensity or luminance. The general description given here often uses the more general lay meaning, connoting distribution, and not necessarily image-removing. The context shall inform accordingly.

Display Light Sensor—shall include any and all devices that would utilize light from a display D in an intelligent manner, and shall not only include conventional photoelectric cells and charge-coupled devices, but optical circuits that utilize light obtained from a display to help control a light source according to the invention.

Distributive outer frame—shall refer to that portion of an active diffuser frame which rebroadcasts light obtained from a light source, which can include a light guide. A distributive outer frame can be remote, such as an optical body in optical communication with a light source or guide, such as an optical fiber or light pipe. The distributive outer frame typically is a material body forming the outer surface of the active diffuser frame system. However, in its most general form, a distributive outer frame shall be defined here and in the appended claims the final active diffuser frame component which interfaces the ambient space around a display, including possibly a human observer or user, with the active diffuser frame system, that is, the final active diffuser frame component that handles or carries light prior to dissemination or broadcast through space to a human observer or to a ambient surface, such as any object or wall in the vicinity of the active diffuser frame. The distributive outer frame thus shall not include any “back wall” or other such ambient surface upon which ambient light emitted by an active frame of this invention impinges. The distributive outer frame permits mixing of light for object mode and illuminant mode ambient light production.

Frame light modulator—shall refer to any modulator of incident light which imparts a character—image forming or not—to same. It can include well known modulators, such as TFT (thin film transistor) LCD (liquid crystal display), and can also comprise a reflective absorber or transmissive absorber. Such a frame light modulator can also comprise an auxiliary light source, making the modulator a light source in its own right. A frame light modulator can also comprises other devices, such as a goniophotometric device or component.

Goniophotometric—shall refer to the quality of giving different light intensity, transmission and/or color as a function of viewing angle or angle of observation, such as found in pearlescent, sparkling or retroreflective phenomena.

Goniochromatic—shall refer to the quality of giving different color or chromaticity as a function of viewing angle or angle of observation, such as produced by iridescence.

Imaging light—or image light is light which allows a standard observer or any other observer to discern the appearance or likeness portrayed by a display, such as light which passes through a splitter prism according to one embodiment of the invention, allowing the original likeness of the video display image to be transmitted to a viewer.

Light guide—shall denote any structure or that portion of an active diffuser frame that receives light from a light source according to the invention. A light guide can be in mechanical contact with the display unit, such as a Lucite® prism mounted in front of same, or it can be suspended or remote, and merely interposed to be in optical communication with the display, or with a light source, such as an LED panel or an electroluminescent device. An active diffuser frame, such as one taking the form of a prism block, can integrate both the functions of the light guide and the distributive outer frame. They do not have to be separate components. In its most general form, a light guide shall be defined here and in the appended claims as anything, whether an optical or material body, or even an evacuated space or air space—that interfaces a light source according to the invention with another component in the frame, such as a frame light modulator, a distributive outer frame, a photoluminescent emitter, or any combination thereof.

Light source—shall denote a light source that by design is controllable, that is, capable of varied output based on an active frame input, and shall, in the absence of any separate description for controlling devices, include any processors or circuits needed for such controlled operation, as well as any modulators needed for effecting control. For example, display output light K or K+ coupled from a video display unit through a light guide LG can be controlled using an frame light modulator AM (see, for example FIGS. 11, 16, 28, and 30). The light producing components in such a light source can include any number of known light generating sources, including cold cathode fluorescent lamps, lasers, FEDs (Field Emission Displays), PDPs (Plasma Display Panels), LEDs (light emitting diodes), electroluminescent devices, or sub-displays, and can include passive light obtained directly from the video display unit which this invention serves, or light originated from or modified by a frame light modulator. Display light modified by a frame light modulator such as an LCD display or other device that modulates light for retransmission shall be considered a light source in the appended claims, even though the description enumerates and shows light source LS as a separate component.

Output light—shall, in connection with a light source, connote light which is originally derived from a light source, such as video display light or LED light, but which may have been subsequently modified, such as by use of a frame light modulator, or a photoluminescent emitter.

Passive optical input—shall refer to input of display light into active diffuser frame system without invention by a processor.

Processor—shall include not only all processors, such as CPU's (Central Processing Units) that employ traditional electronic techniques and architecture, but also any intelligent device that can allow changing the character of ambient light produced as a function of an active frame input, such as digital optical devices, or analog electrical circuits that perform the same functions.

Transparent—shall include somewhat transparent, as well as nearly 100% transparent.

Video—shall denote any visual or light producing device, whether an active device requiring energy for light production, or any transmissive medium which conveys image information, such as a window in an office building, or an optical guide where image information is derived remotely.

Video signal—shall denote the signal or information delivered for controlling a video display unit, including any audio portion thereof. It is therefore contemplated that video content analysis includes possible audio content analysis for the audio portion.

The various embodiments for active diffuser frame systems described here emit ambient light to an ambient space about a video display unit. The active diffuser frame system can use any or all of three active frame inputs, including possibly the display video signal, for use in controlling a light source inside itself. This disclosure shall cover various possible and illustrative physical embodiments, and later, various illustrative functional inputs and control of the active frame light source.

Referring now to FIG. 1, an illustrative frontal surface view of a rectangular video display D is shown, having a total active or light producing frontal surface area DA equal to the product of height h and width w, as shown. Display D can comprise a number picture elements or pixels U which produce display output light K, as shown. A peripheral area, shown as FA, serves for illustrative purposes as a fiducial area dedicated for production and distribution of ambient light using one embodiment of the instant invention.

Referring now to FIG. 2, a frontal schematic view of a conventional RGB video pixel in the display of FIG. 1 is shown for illustrative purposes. As with most displays, display output light K from subpixels or constituents portions of pixel U is multi-directional, so that the video display D can be viewed conveniently from a wide range of angles. This multi-directionality of output will be used to advantage, such as found in the embodiment described in FIG. 20.

Now referring to FIGS. 3 and 4, schematic cross-sectional side views are shown of a cathode-ray tube display and a flat panel display, respectively. In each figure, display D is oriented so that its display output light K is emitted in multiple directions to the right on the page as shown, in a general output light outward direction D(K) as shown. Each display D is fitted with one active diffuser frame A according to the invention so that it is in optical communication with the display, capturing light from the fiducial area FA as shown in the surface view of FIG. 1. For clarity, only the active portion of displays are shown here, so that the full display height h as shown is active. At some distance away in the general direction D(K) is an observer or viewer Q, shown schematically as an eye section.

Now referring to FIG. 5, a close-up view of the upper portion of the schematic cross-section of FIG. 4 is shown. The upper portion of the side of display D is shown optically coupled to active diffuser frame A. Active diffuser frame A can be mounted mechanically onto display D, and can include flanges and slip-on geometry for that purpose, or it can be suspended to be merely in optical communication with display D. Active diffuser frame A can be made of a number of commonly available transparent or translucent materials such as clear plastics like Lexan®, Lucite®, and many other polymer resins, such as PET and ABS resin, and formed using known fabrication techniques. Any known stable light transmissive material can be used that has requisite mechanical and optical properties. The portion of active diffuser frame A which allows display output light K to enter and optically couple into the active diffuser frame A shall be called a light guide; and the portion that serves to rebroadcast that light to become ambient light shall be called a distributive outer frame (shown, AF), as will be noted below, such as in the Definitions section of this disclosure. Distributive outer frame AF can comprise a distributive frame outer surface AS, as shown. Display output light K can be redirected, shown as redirected light J, to become ambient light M as shown. Ambient light M can be emitted in any direction, such as toward a viewer Q as shown, and also in directions contrary to general output light outward direction D(K), such as spilled light (shown, Spill) away from viewer Q. In this example, ambient light is shown spilling onto a back wall N in ambient space behind display D, becoming ambient reflected light MR, which presumably can be seen by the viewer Q along with original display image light sent in the general output light outward direction D(K). Active diffuser frame A, and in particular, distributive frame outer surface AS, can embody various diffuser effects to produce light mixing, as well as translucence or other phenomena, such as a frosted or glazed surface AS; or ribbed glass or plastic; or apertured structures, such as by using metal or other internal blockers, depending on the visual effect desired. A simple active diffuser frame A is shown here for clarity. It is not necessary for active diffuser frame A to make use of original display light, as will be shown below.

Now referring to FIGS. 6 and 7, one general effect is shown illustratively. FIG. 6 shows an oblique schematic surface view of the upper right portion of a display D, fitted with a generalized block active diffuser frame system according to one embodiment of the invention. As shown in FIG. 6, it is expected, but not required, that active diffuser frame A will be peripheral in nature, and can use—but does not have to use—light from a fiducial area FA on the display periphery or in any desired area. Only a portion of the frame is shown for clarity. Notice how ambient light M can be emitted in directions in an ambient space Z contrary to general output light outward direction D(K), including the sides and top of the display D. Viewer Q thus receives original display image light 1 as shown from non-fiducial areas of the display, as well as ambient light M emanating from active diffuser frame A as shown. Not shown here or in FIG. 5 is an active frame controllable light source (LS) inside active diffuser frame A which can be controlled in part based upon display output light K or other active frame inputs, as will be shown below.

The general effect is shown illustratively in FIG. 7, where a frontal schematic view is shown of a display D using an active diffuser frame A which captures some display scene light (a sun and rudimentary ground features are shown) from the fiducial area FA as shown in FIG. 1. This light is captured using a light guide (not shown) for use by the active diffuser frame system to send light out a distributive outer frame AF (shown) into the ambient space as ambient light M. There are no limits on the geometry of distributive outer frame AF, shown here having a height H and width W larger than height h and width w of the surface area DA of active display D as shown in FIG. 1.

Now referring to FIGS. 8, 9, and 10, a non-interceptive active diffuser frame system embodiment is shown, in analogy to the views of FIGS. 5, 6, and 7. FIG. 8 shows a close-up view similar to that of FIG. 5, but for a non-interceptive embodiment where the active frame, in generating its own light, does not intercept light from the video display unit. The active diffuser frame A is now shown with its light source LS as shown, which originates light, with a representative schematic light ray LJ shown which provides radiative energy for producing ambient light M as shown. Light source LS can comprise any of the following: [1] an LED (Light Emitting Diode), [2] an electroluminescent device, [3] an incandescent lamp, [4] an ion discharge lamp, [5] a laser, [6] an LCD (Liquid Crystal Display) [7] a frame light modulator, [8] a photoluminescent emitter, or any number of known controllable light sources, including arrays that functionally themselves resemble displays.

FIG. 9 shows a view similar to that of FIG. 6, but showing a schematic surface view for the non-interceptive embodiment of FIG. 8. Notice that the active diffuser frame A does not obscure or intercept original display image light 1. The analogous frontal schematic view of a display D using an active diffuser frame A is shown in FIG. 10, where, as can be seen, the active diffuser frame A does not intercept or make use directly of original display light.

Distributive outer frame AF can, as illustrated here schematically, comprise a diffuser to change the character of the ambient light produced. Any number of known diffusing or scattering materials or phenomena can be used, including scattering from small suspended particles inside the diffuser body; rigid foam; clouded plastics or resins, preparations using colloids, emulsions, or globules 1-5:m or less, such as less than 1:m, including long-life organic mixtures; gels; and sols, the production and fabrication of which is known by those skilled in the art. Scattering phenomena can be engineered to include Rayleigh scattering for visible wavelengths, such as for blue production for blue enhancement of ambient light. The colors produced can be defined regionally, such as an overall bluish tint in certain areas or regional tints, such as a blue light-producing top section.

Now referring to FIGS. 11 and 12, another embodiment of the invention is shown whereby the active diffuser frame A is functionally goniophotometric, and uses as an active frame input the passive sensing of display output light from the video display unit using a display light sensor or sensors. FIG. 11 shows, in analogous fashion to FIG. 5, a generalized schematic cross-sectional view of an upper portion of an active diffuser frame system according to the invention, where, as can be seen, display output light K from display D is conveyed using a light guide (not explicitly shown for clarity) to a display light sensor DS. Display light sensor DS can comprise a single sensor, or can comprise a plurality of sensors, such as a sensor block which can use any number of known light-sensitive transducing devices such as photoelectric cells, or charge-coupled devices to transduce display output light K into electrical or other signals for use by a processor, not shown, to control light source LS as shown. Display light sensor DS is packaged inside active diffuser frame A using a separator S as shown to prevent passage of light and/or heat from light source LS to display light sensor DS. Light source LS originates frame light which passes as active frame light ray LJ as shown through a light guide LG now explicitly shown. Light guide LG guides light from light source LS into distributive outer frame AF, with ambient light, now shown as frame non-image light 3 passing into ambient space about display D. Notice that frame non-image light 3 can again pass leftward on the drawing figure to spill backward, as also shown in FIG. 5. The active diffuser frame A, and specifically here, for illustrative purposes—distributive outer frame AF—is shown fitted with one type of goniophotometric element AN, shown here as a cylindrical prism or lens which can be formed within, integral to, or inserted within light guide LG and/or, as shown here, distributive outer frame AF. This allows special effects where the character of the frame non-image light 3 produced changes as a function of the position of the viewer. FIG. 11 demonstrates the goniophotometric effect which gives different light intensity and character for frame non-image goniophotometric light 4 as a function of viewing angle. Light from light source LS enters the cylindrical prism or goniophotometric element AN through light guide LG, as shown. In the sample light rays shown, light is non-isotropically redirected out of the goniophotometric element AN—depending on the entry point on the cylindrical surface of the cylindrical prism used, as shown—and in such a way that a viewer or human observer Q at a middle vantage point as shown would perceive a different light intensity from the goniophotometric element AN than a vertically lower observer −Q or a higher observer+Q as shown. This effect can, for example, allow a user or viewer to see this effect upon rising from a chair, or can allow a user to make a small adjustment in viewing position to obtain a different light perceived light level or intensity from the goniophotometric element AN. This allows, based on small changes in viewing position, changing the intensity of ambient light produced, based on personal preference. Other optical shapes and forms can be used, including rectangular, triangular or irregularly-shaped prisms or shapes, and they can be placed upon or integral to distributive outer frame AF as desired. Rather than an isotropic output, the effect gained here can be infinitely varied, e.g., bands of interesting light cast on surrounding walls, objects, and surfaces placed about the display D, making a sort of light show in a darkened room as the scene elements, color, and intensity change on the video display unit. The number and type of goniophotometric elements that can be used is nearly unlimited, including pieces of plastic, glass, and the optical effects produced from scoring and mildly destructive fabrication techniques. The active diffuser frame A can be made to be unique, and even interchangeable, for different theatrical effect.

The appearance of the active diffuser frame A and display D is shown in FIG. 12, where a frontal schematic view similar to that of FIG. 7 is shown for the goniophotometric active diffuser frame system of FIG. 11. Display D emits original display image light 1 as shown. With distributive outer frame AF having a diffuser core or feature, ambient light M takes the form of frame non-image light 3 as shown, and also takes the form of frame non-image goniophotometric light 4 which emanates from the goniophotometric element AN shown in cross-section in FIG. 10.

Now referring to FIGS. 13 and 14, generalized schematic cross-sectional views of an upper portion of a non-interceptive active diffuser frame system according to the invention are shown which utilize an active video signal supplied to the video display unit to control light source LS inside active diffuser frame A. In FIG. 13, a video display signal RF is shown schematically as being obtained from display D, in any known manner, including pickoff of the signal using a consumer-supplied adapter, or some integral method where the signal is obtained from inside the display D, including known inductive sensing or wholesale tap of a signal line or transmission line, including any coaxial line, optic fiber, radio link, or any other source of the signal or bitstream that provides video information and any associated data to the display D. This could include infrared, Bluetooth or pulse-width modulated communications from display D to processor CPU as shown. Known compression techniques can be used for such communications. The data tapped into for video display signal RF can comprise analog signals, such as NTSC, PAL or SECAM waveforms, or can constitute digitized information, including source coding and any subcodes or ancillary data, or metadata. Video display signal RF is then utilized using known principles in the art of video and television engineering by the processor CPU, shown here as being integral with or affixed to active diffuser frame A as shown. Alternatively processor CPU can be incorporated into display D, or can be located independently of either active diffuser frame A or display D. As before output light from light source LS passes through light guide LG and out to distributive outer frame AF, producing frame non-image light 3.

In FIG. 14, another embodiment is shown where the active diffuser frame system utilizes remote sensing such as electromagnetic couplers EC1 and EC2 for the active frame input of the video display signal RF delivered to the video display unit. In this embodiment, the video display signal RF, a portion thereof, or a signal derived from video display signal RF is used to directly or indirectly, using techniques known in the electronic and electrical arts, to drive electromagnetic coupler EC1 in such as a way as to encode the desired information from video display signal RF. If needed, there can be some processing done to simplify the video signal, such as sampling only a subset of the pixels in the display, averaging techniques, or other compressive sampling techniques that might allow reduction in the data load on any driver needed (not shown) to feed electromagnetic coupler EC1. In an analogous fashion, processor CPU can make use of a signal inductively or electromagnetically received by electromagnetic coupler EC2, which is in electromagnetic communication with electromagnetic coupler EC1. This allows easy portability of active diffuser frame A, particularly for flat panel (non-CRT) displays. Electromagnetic couplers EC2 can take the form of antennae, or can be overtly optical devices, such as those commonly available and known in the art that utilize IRED (infra-red light emitting diodes) or similar emitters to encode and transmit signal information. Any number of configurations can be used. For example, electromagnetic coupler EC1 can be part of, or affixed to, or associated with display D, while electromagnetic coupler EC2 can be part of active diffuser frame A, allowing portability and interchangeability.

Now referring to FIG. 15, an active diffuser frame A is shown according to an other embodiment that resembles that shown in FIG. 13, where output light from light source LS is modulated by a frame light modulator AM. As can be seen, frame light modulator AM is now part of distributive outer frame AF, and is interposed between light source LS and distributive outer frame surface AS, so that the character, such as intensity, hue or saturation, of light emerging from light source LS can be altered prior to ambient distribution, becoming what is termed here as modulated ambient light 3M, as shown. This can allow for any number of lighting effects whose execution is determined by content derived from an active frame input, such as video display signal RF. Frame light modulator AM can comprise a single device that changes transmission or throughput as a function of time or position, or an array, such as a planar array of such devices, such as found in an LCD (Liquid Crystal Display), or a combination device that allows passage of light through itself, but also is itself an active source of light such as a FED (Field Emission Display) or PDP (Plasma Display Panel).

As another example, and now referring to FIG. 16, a view similar to that of FIG. 15 is shown, but for another embodiment using a partially interceptive configuration, whereby some display output light K is also allowed to enter light guide LG, as is done in the embodiment of FIG. 11. In this embodiment, both display output light K and output light from light source LS pass through light guide LG, and outward to ambient space through distributive outer frame AF. Processor CPU is not shown there for clarity.

Using a frame light modulator AM, a scene can be projected onto distributive outer frame AF which supplements, in a pleasing way, content from display D. The derivation of control signals to produce that content start from an active frame input derived from the video display unit D, and do not have to come from a script or subcode or dedicated data space in video display signal RF.

The light redirected by the distributive outer frame AF can be non-imaging and mixed, allowing combinations of primary or other colors. This allows mixing such as that shown in FIG. 24 so that two colors A and B from two distinct scenes areas on the display can form a chromaticity C not shown on the original image, but pleasing to the eye, as it is derived from original image content. Thus, while the light provided to distributive outer frame AF can be distinct, e.g., separate red and green areas, the ambient light 3M produced by the active diffuser frame can be yellow, providing an interesting theatrical effect. This is particularly enhanced when distributive outer frame AF comprises a diffuser. This can produce object mode colors such as brown, from sources of light for which brown is difficult to produce, such as an array of LEDs.

Now referring to FIGS. 17 and 18, basic schematic block diagrams for illustrative light flows in the embodiments shown in FIGS. 15 and 16, respectively, are given. In FIG. 17, a light source (shown, Light Source) and in FIG. 18, a light source and some display light (shown, Display) emerge as RGB component light, or frame light as called in the appended claims, and in both cases this light passes through light guide LG as shown, and onward to frame light modulator AM as shown, which is shown removing some portion of green (G) light, as shown by the weakened schematic arrow representing transmitted green light. This modulated light passes through the distributive outer frame AF and, in our illustrative embodiment, mixes together to form magenta light (shown, Magenta) which is broadcast into ambient space. This chrominance selection can be modulated as a function of a position on the distributive frame outer surface AS, and as a function of time, using known methods for controlling frame light modulator AM as a function of the behavior of display D, gleaned from one or more active frame inputs.

FIG. 19, shows another embodiment similar in some ways to that shown in FIG. 16, but where the active diffuser frame system supplements the video signal provided to the video display unit to produce modified video display light, and also comprising an illustrative goniophotometric element as shown in FIG. 11. This embodiment of the invention allows that processor CPU (not shown for clarity) can utilize either passive sensing of display output light K or the video display signal RF to generate a fiducial area video signal (discussed below) that is provided to the video display unit D to drive or boost (or suppress luminance, if desired) selected output pixels in the video display unit that reside in the fiducial area FA as shown in FIG. 1 to produce modified display light (K+) as shown. This can allow, for example, a boost in the light production, because there exist now two new light sources with respect to the original display D: light source LS in active diffuser frame A and modified display light K+ from display D as shown. As before, modified display output light K+ and output light from light source LS pass through light guide LG, and onward through frame light modulator AM and distributive outer frame AF. Some of this light in this illustrative example passes through goniophotometric element AN, producing what is now shown as frame non-image goniophotometric light 4M, which can change character as function of viewing angle as shown.

In another embodiment of the invention, light guide LG can allow simultaneous transmission of original display light from a fiducial area FA to an observer, and still allow pumping or utilization of display light for use by the active diffuser frame system.

Now referring to FIG. 20, such an embodiment is shown using a close-up cross-sectional view of the upper portion of a display D showing a fiducial area (not labeled for clarity) fitted with a splitter-prism equipped active diffuser frame system. Here light guide LG takes the form of a right prism as shown, and is so formed as to provide a critical surface upon which 100 percent internal reflection can occur.

Specifically, light guide LG and/or distributive outer frame AF is formed as shown to allow that a critical surface CS exists at or near the critical angle for total internal reflection. The front face of distributive outer frame AF shown on the right of the figure is beveled to form a critical surface CS whose normal vector is about 45 degrees off from general output light outward direction D(K). Since the critical angle for internal reflection of most plastics is typically about 42 degrees, this presents an opportunity to split the light entering the light guide LG, because with the geometry chosen, approximately half the light entering will exceed the critical angle to become internally reflected output light KX as shown, later becoming frame modulated ambient light 3M as it passes through a top-mounted frame light modulator AM as shown—while the other half of the light entering light guide LG will not be so redirected, but rather will pass forward to become transmitted output light KT and to become frame image light 2 as shown. Thus, the viewer will perceive or discern the original character of the original display image in the fiducial area FA and yet, at the same time, light is available for pumping upward from distributive outer frame AF for ambient distribution. This diaphanous or transparent active diffuser frame A thus allows viewing of the original display image throughout the entire display area under reduced intensity, which is not particularly noticed because of inherent compensating characteristics of the human visual system. Small deviations from straight exit for transmitted output light KT are not shown for clarity.

The internally reflected output light KX thus redirected can be used as an input by the active diffuser frame system, and it is possible to substitute display light sensor DS in lieu of frame light modulator AM, or any combination of the two, to further provide information to the active diffuser frame A and any associated processor CPU (not shown).

An additional feature is shown as well, namely the use of a frontal reflector or reflective surface T to reflect light internal inside the light guide LG to become ambient spill light (shown, Spill). This light can illuminate a back wall as shown in FIG. 8.

As an alternative embodiment to the splitter prism embodiment illustrated in FIG. 20, FIG. 21 uses a partially reflective surface T2 in lieu of internal reflection at the critical surface CS. As before, some light, namely internally reflected output light KX, is reflected upwards for use as an input for active diffuser frame A, such as by passing through frame light modulator AM as shown, and/or alternatively, a display light sensor DS (not shown). Other light is transmitted to become transmitted output light KT as before. Now the light guide and distributive outer frame AF, incorporated into one physical block component here, can be largely hollow as shown, with light paths as shown before in FIG. 20. Using a partially reflective surface T2 can be advantageous because there are no refractive displacement effects on the image to be discerned across critical surface CS as there are with the refractive internal reflection as shown in FIG. 20; however, using a partially reflective surface has the disadvantage of introducing some optical loss at the reflective surface, while the 100 percent internal reflection at critical surface CS of FIG. 20 is absolute. As before in previous FIG. 20, a frontal reflector T is used to enhance back spill of ambient light as shown across the top of the display D. As an alternative to a continuous partially reflecting surface T2, one can use selective reflectors or partial reflectors on a small physical scale which individually reflect and redirect some display light to become spill, while other light passes between such selective reflectors to add to frame image light 2.

Generally, the teachings given here can be applied in a multitude of ways. The splitter prism geometry for light guide LG and/or distributive outer frame AF can comprise a single plane for entire frame, alternatively, the splitter prism can comprise four planes, one for each side of the display fiducial border (see FIG. 1), namely, the top, bottom, left & right sides. Alternatively, there can be regional prisms or small prisms, even pixel-size prisms to achieve the same effect on a small scale.

Distributive outer frame AF can also comprise one or more light pipes (not shown) for further exiting or distribution of ambient light to specific places in the ambient space or for specific purposes, not shown. For example, a light pipe can be affixed to the back of distributive outer frame AF in FIG. 20 or 21, adjacent to where Spill light exit backward as shown. Ambient light M emanating from such light pipes can be optically pumped into other optical structures for use elsewhere, such as a floor mounted optical distributor (not shown) or a ceiling splash unit (not shown) for special effects. The light pipes could also be used to convey light for amplification for the purpose of ambient distribution.

One of the functions obtainable by the present invention is the production by the active frame of chromaticities derived from, but not actually present, in the original display image light 1. This can be done without reliance on hot or active sources of light, such as LEDs whose chromaticity, even when primary colors are combined, is hard to control as previously mentioned. For example, original display image light 1 can be color transformed or color modulated. This allows exploiting characteristics of the human eye and visual system. It should be noted that the luminosity function of the human visual system, which gives detection sensitivity for various visible wavelengths, changes as a function of light levels.

For example, scotopic or night vision relying on rods tends to be more sensitive to blues and greens. Photopic vision using cones is better suited to detect longer wavelength light such as reds and yellows. In a darkened home theatre environment, such changes in relative luminosity of different colors as a function of light level can be counteracted somewhat by modulating or changing color delivered to the video user in ambient space. This can be done using a color subtraction step using a frame light modulator AM, or by using teachings of another embodiment of the invention shown in FIG. 22, where the top portion of FIG. 21 is shown, but equipped with an added component, namely a photoluminescent emitter to further modify light before ambient release. As internally reflected output light KX as shown in prior FIG. 21 emerges upward in FIG. 22, it passes as before through frame light modulator AM, and then upward further through a photoluminescent emitter PE which is applied to, affixed to, or integral with the frame light modulator AM, as shown. As another example, and now referring to FIG. 23, another embodiment of the invention similar in function to that shown in FIG. 15 is shown, additionally also comprising a photoluminescent emitter PE interposed between frame light modulator AM and distributive frame outer surface AS. In this case, output light from light source LS passes through light guide LG, then through frame light modulator AM to be broadcast by distributive outer frame AF for ambient release to ambient space. Alternatively, photoluminescent emitter PE can be integral with distributive outer frame AF.

The photoluminescentminescent emitter PE performs a color transformation by absorbing or undergoing excitation from incoming light from light source LS or from display output light K (e.g, KX) and then re-emitting that light in higher desired wavelengths. This excitation and re-emission by a photoluminescent emitter, such as a fluorescent pigment, can allow rendering of new colors not originally present in the original video image or light source, and perhaps also not in the range of colors or color gamut inherent to the operation of the display D.

FIG. 24 shows a basic schematic block diagram for an illustrative light flow for this process, such as the embodiment given in FIG. 23. RGB light from a light source (shown, Display or Light Source) passes into a frame light modulator AM such as a TFT LCD display, and then on to a photoluminescent emitter PE, where excitations or absorption in various wavelength ranges produces via additive mixing (at a distributive frame outer surface AS, for example) an orange color O which provides a new color (shown, Orange Boost) not originally present in the display or light source.

The production of new colors can provide new and interesting visual effects. The illustrative example can be the production of orange light, such as what is termed hunter's orange, for which available fluorescent pigments are well known (see ref[2]). The example given involves a fluorescent color, as opposed to the general phenomenon of fluorescence and related phenomena, for which the figure is otherwise dedicated outside the specific example of hunter's orange. In other words, any photoluminescent compound, substance or material can be used for photoluminescent emitter PE, so long as it has activation or excitation potential for responding to the light sources or sources inside active diffuser frame A.

Using a fluorescent orange or other fluorescent dye species can be particularly useful for low light conditions, where a boost in reds and oranges can counteract the decreased sensitivity of scotopic vision for long wavelengths.

Fluorescent dyes can include known dyes in dye classes such as Perylenes, Naphthalimides, Coumarins, Thioxanthenes, Anthraquinones, Thioindigoids, and proprietary dye classes such as those manufactured by the Day-Glo Color Corporation, Cleveland, Ohio, USA. Colors available include Apache Yellow, Tigris Yellow, Savannah Yellow, Pocono Yellow, Mohawk Yellow, Potomac Yellow, Marigold Orange, Ottawa Red, Volga Red, Salmon Pink, and Columbia Blue. These dye classes can be incorporated into resins, such as PS, PET, and ABS using known processes.

Fluorescent dyes and materials have enhanced visual effects because they can be engineered to be considerably brighter than nonfluorescent materials of the same chromaticity. So-called durability problems of traditional organic pigments used to generate fluorescent colors have largely been solved in the last two decades, as technological advances have resulted in the development of durable fluorescent pigments that maintain their vivid coloration for 7-10 years under exposure to the sun. These pigments are therefore almost indestructible in a home theatre environment where UV ray entry is minimal.

Alternatively, fluorescent photopigments can be used, and they work simply by absorbing short wavelength light, and re-emitting this light as a longer wavelength such as red or orange. Technologically advanced inorganic pigments are now readily available that undergo excitation using visible light, such as blues and violets, e.g., 400-440 nm light.

Highly fluorescent materials give rise to a unique color glow with seeming unnatural brilliance, known as fluorence, the psycho-physical perception of fluorescent color phenomena.

While this phenomenon remains largely unexplored, the relationship between the maximum theoretically achievable luminance (relative to white) as a function of chromaticity was quantitatively modeled by MacAdam (1935) and has since been known as the MacAdam limit in the color science literature. It has been suggested that fluorence can be specified by Y/YMacAdam (x,y), where Y is the relative reflectance or apparent reflectance of the fluorescent colored stimulus, and YMacAdam (x,y) is the MacAdam limit for the chromaticity coordinates (x,y) of the fluorescent colored stimulus.

FIG. 25 shows a comparison between the color transformation process of FIG. 24 according to the invention with that of conventional video color production by the display or a conventional light source for the nearest available chromaticity. As shown on the left side, an original video image or light source using primaries R, G and B produces a new orange color not inherently producible by the display or light source, as shown in FIG. 24. This out-of-gamut light is shown as ambient light M+. Compare this to production of the same color of nearest chromaticity using light inherently produced by the display or light source, where as an illustrative example, light comprising a high intensity of red light (shown, R) and a smaller intensity of green light (shown, g) is filtered subtractively by frame light modulator AM to produce an orange color (shown, Orange) which is still within in the gamut of colors inherently producible by the display or light source associated with active diffuser frame A. The figure shows graphically that the light produced by an active diffuser frame system using a photoluminescent emitter according to the invention can exceed the MacAdam limit for that chromaticity.

FIG. 26 shows generally in a block schematic form the process by which fluorescence can be used by the active diffuser frame of the invention to produce a color outside the gamut of colors ordinarily produced by the video display. The RGB light from Display Color Gamut (RGB) is allowed to excite a fluorescent substance inside photoluminescent emitter PE, allowing production of colors by distributive outer frame AF outside the gamut of colors available by inherent operation of display D or light source LS. This is shown graphically in FIG. 26, where fluorescence results in production of an out-of-gamut color.

For illustrative purposes FIG. 27 shows a prior art plot of activation, reflection, fluorescence, and total output spectral distributions for a fluorescent material (hunter's orange) that might be used for the embodiment illustrated by FIGS. 22, 23, 28 and 30 (from ref[2], page 365). Photoluminescent emitter PE in this example is excited by shorter wavelengths shown as E. Ordinary reflectance processes shown by R are supplemented by a fluorescent emission spectral distribution shown by F, adding to give rise to a high-output total emission shown as HO, which can lie outside the inherent color gamut of display D.

FIG. 28 shows a cross-sectional oblique view of a portion of a simple splitter prism distributive outer frame AF which is integral with light guide LG. Some light from a light source, such as light source LS (not shown) or display output light K (not shown) is redirected so as not to become frame image light 2, e.g., the blue light shown. Instead, this light is internally reflected and sent upward in the figure toward a frame light modulator AM and then subsequently through photoluminescent emitter PE pad as shown at the top of the distributive outer frame AF. This converts the light output (e.g., blue light) in a manner similar that shown in the spectral distribution plot of FIG. 27 to out-of-gamut orange light, emerging as ambient frame non-image light 3 as shown to the ambient space.

Such a process can easily produce ambient light outside the color gamut inherent to the display D. Referring now to FIG. 29, two possible ambient colors or chromaticity coordinates shown as M+can be found on a standard CIE x-y chromaticity diagram or color map. The map shows all known colors at maximum luminosity as a function of chromaticity coordinates x and y, with nanometer light wavelengths and CIE standard illuminant white points shown for reference. The chromaticity of ambient colors M+ are readily shown to lie outside the gamut of colors obtainable by PAL/SECAM, NTSC, and Adobe RGB tristimulus color production standards as shown.

The photoluminescent emitter PE can incorporate reflective fluorescent materials, with the distributive outer frame AF formed and adapted to use reflection as a color modulation method inside active diffuser frame A, not just absorption and re-emission.

It should also be noted that any number of known phosphorescent materials with long relaxation times (e.g., longer than 10̂-8 seconds, such as 1 second) can be substituted for or added to a fluorescent material in photoluminescent emitter PE. This can allow for special effects, such as a time delay or drag in the progress of luminescence of the active diffuser frame A as scene elements play out on display D. This effect can make the ambient light output look scripted.

In another embodiment of the invention, FIG. 30 shows another cross-sectional oblique view of a portion of a simple splitter prism distributive outer frame AF which is integral with light guide LG but additionally comprising a goniophotometric and goniochromatic element AN to produce different light colors, intensity, and character as a function of viewing angles Theta and Phi as shown. Phi is measured in a horizontal plane, and theta is measured in a vertical plane. As shown, a simple splitter prism serving as a combination light guide LG and distributive outer frame AF is shown receiving input light R, G, and B from a light source (not shown), such as light source LS or display output light K. As before in FIG. 28, some RGB light is internally reflected upward to pass through frame light modulator AM and an photoluminescent emitter PE both of which can be optional. However, here, the light guide LG is in optical communication with a goniophotometric element AN, shown here as a front face FF, and part of distributive outer frame AF. Light emerging from photoluminescent emitter PE can exit the front face FF directly, or be reflected from rear reflector RR, which helps guide light out of front face FF. As can be seen, many color-differentiated effects can be established as a function of viewing angle, shown schematically here light rays as shown such as low intensity green light g, and high intensity yellow light Y, orange light O, red light R, and blue light B. To realize this effect, goniophotometric element AN in the form of front face FF can use many known goniophotometric and goniochromatic elements, alone, or in combination, such as metallic and pearlescent transmissive colorants; iridescent materials using well-known diffractive or thin-film interference effects, e.g., using fish scale essence: thin flakes of guanine, or 2-aminohypoxanthine with preservative. Finely ground mica or other substances can be used, such as pearlescent materials made from oxide layers, bornite or peacock ore; metal flakes, glass flakes, plastic flakes, particulate matter, oil, ground glass, and ground plastic.

The front face FF can be treated, formed or scored to provide goniochromatic effects. For example, front face FF can comprises indentations, ribs, frosted areas, inclusions, including trapped air or particles, such as pieces of resin or glass. The goniochromatic effects can be effected through the use of either reflective or transmissive materials, as will be appreciated by those skilled in the art. It should also be noted that the embodiment described in FIG. 11 can be mildly goniochromatic due to dispersion phenomena available by use of a prism or lens.

The effect of such an active diffuser frame A can be a theatrical element which changes light character very sensitively as a function of viewer position—such as viewing bluish sparkles, then red light—when one is getting up from a chair or shifting viewing position.

To illustrate this, FIGS. 31 and 32 show Cartesian plots of dominant color wavelength of ambient light produced versus viewing angles Phi and Theta, respectively, for the goniochromatic embodiment illustrated in FIG. 39, using a iridescent front face FF. The wavelength or color of the light changes as a function phi and theta, respectively.

Scoring or other treatment of front face FF, including inclusion of small color elements therein, allows that light intensity changes goniophotometrically as shown in FIG. 33, which shows a Cartesian plot of relative light intensity of ambient light produced versus viewing angle Phi, for the otherwise goniochromatic embodiment illustrated in FIG. 30.

Generally, multiple optical elements, including small elements, can be used for multiple feeds to the distributive outer frame. The simple configurations chosen here for illustrative purposes shall not be deemed limiting in any way. Small light sources LS can be used, along with internal structure that routes light to specific places on distributive frame outer surface AS, for example.

Active diffuser frame systems according to the invention can be embodied in the larger context of overall systems, such as an entertainment center or computer peripheral. The processors or the equivalent for use in controlling light source LS or for modulating display output light K, or for creating modified display light K+, as discussed above, can be located inside display D; inside active diffuser frame A—such as inside any light source LS, inside light guide LG, or inside distributive outer frame AF—or alternatively, can be affixed to any of these, or external to any of these.

The control of a light source in active diffuser frame A can be a function of many things, including one or more active frame inputs from the video display unit (display light, signals from display light transducers such as display light sensor DS, and video content gleaned from video display signal RF), and can optionally include inputs regarding viewing room or ambient space conditions, user preferences, or other optional information inputs like pre-recorded or transmitted scripts.

FIG. 34 shows another embodiment of the invention, similar to that shown in FIG. 15, but additionally comprising a frame touch sensor ST on an outer surface AS of the distributive outer frame AF. The frame touch sensor ST can be substantially transparent and made using known techniques such as pressure sensitive semiconductor films, capacitive sensors, microphone technologies, or planar switches, and can, using known designs, take a form different than shown, such as in the form of a discrete accelerometer, such as a piezoelectric accelerometer (not shown) affixed to active diffuser frame A, or alternatively in the form of a purely capacitive sensor which does not directly measure vibration, but rather, contact with a conductive body, such as a human body when manually touched. Using frame touch sensor ST to transduce a touch, tap or other vibration into a transient or other electrical signal or optic signal, a user can inform a processor (not shown) about a preference.

For example, touching or tapping active diffuser frame A can cause the character of the ambient frame light produced to toggle between bright, fast moving light patterns on distributive outer frame AF, to more subdued patterns and intensity, to no ambient light at all. Conditions can also be monitored in the ambient space about display D, to allow the active diffuser frame A to tailor its ambient output for desired effects. FIG. 35 shows an embodiment similar to that shown in FIG. 9, but additionally comprising a light sensor, and a sound sensor. Light sensor SL is shown illustratively on distributive frame outer surface AS facing the viewer, and can comprise a selenium photocell or other photocell, such as a silicon-germanium light sensitive cell, or other known photosensitive device. Similarly, sound sensor SS comprising a microphone or sound transducer of any known type can be incorporated into active diffuser frame A, such as on the front face as shown.

On or behind distributive outer frame AF of active diffuser frame A, there can be multiple light sources, including planar arrays or displays that are part of the active frame. Frame light modulator AM shown in above figures, can take the form of an LCD display with or without a backlight (not shown).

Referring now to FIG. 36, a close-up schematic cross-sectional view of the upper portion of another embodiment of an active diffuser frame is shown that uses two light sources. In the upper left of the figure, a light source LS, such as an LED array, is positioned to allow production of ambient light M emitted upward and backward (leftward on the page) as shown, while at the front face of active diffuser frame A, an electroluminescent device EL is provided to produce frame electroluminescent light 3EL rightward on the page toward an observer (not shown). A frame touch sensor ST can again be incorporated therein, as shown. Electroluminescent device EL can comprise a planar array or display, and any other luminescent display, such as an LCD, can be substituted therefor. Known electroluminescent devices such as that shown in U.S. Pat. No. 5,895,692 to Shirasaki et al. can be used, where a fluorescent layer is applied on top of an electroluminescent device. Electroluminescent device EL can comprise gas discharge lamps and plasma display panels, or can use direct electroluminescence, such as use of a display using known Destriau effect phosphors, or any number of known charge-injection electroluminescent devices can be used.

Furthermore, electroluminescent device EL can be so designed, formed, and addressed so as to allow that a graphical user interface GUI as shown can be provided on the front face, or any other face, of active diffuser frame A, and the frame touch sensor ST can be a touch-sensitive screen of known design that allows menu choices or other field-sensitive inputs from a user.

FIGS. 37, 38, and 39 give more functional description and can refer to processing modules or subcomponents that provide an illustration of some way to effect embodiments of the invention. There are many configurations possible, as those skilled in the art of electronic design can envision. The functional components given here can reside, individually or together, on a electronic control module, chip, or processor or on a multi-component circuit board, and can include software, memory, and interfacing with outside processors, such as afforded by communicating with a network card.

FIG. 37 shows a functional schematic diagram for control of an active diffuser frame system according to the invention including one active frame input that comprises video content analysis which subsequently is used to influence operation of any of a number of light sources. Solid lines with arrows can indicate controls or signals, such as electrical or optical signals. FIG. 37 elucidates some function as shown in FIG. 38 and relates to light amplification and production. Briefly, in the figure, a processor receives a video display signal RF from display D as shown in prior component figures and can perform video content analysis to generate or derive a desired active frame light control signal or signals (shown as a functional or physical module or unit, Video Content Analysis+Active Frame Light Control Signals) to be used in controlling a light source or sources, such as a planar LED display or an frame light modulator. This can include simple analog signals, such as a driver voltage to regulate output of an LED device, or complex waveforms or digital frames or packets that constitute video signals in their own right, such as video signals used to control a planar array of LEDs or an LCD. Resultant active frame light control signals or data (typically large amounts of data at a high bit rate, indicated by the double arrows) is fed to a Light Amplification+Production Board as shown. This light amplification and production board can include its own microprocessors to in turn control (see double arrow) an interface (shown, Video interface) that produces the desired video production for ambient light to be broadcast. This interface can include known drivers, including power transistors, that are needed to control any number of light sources, and as shown in this example, the interface controls an LED light source (shown, LEDs), other active light sources such as a plasma display panel or laser bank (shown, Other Active Light Sources) and an electroluminescent device (shown, Electroluminescent Device), all of known designs. It is envisioned that one can get self-referential data from these light sources, e.g., current consumption for an LED array, and feed that data back to the Light Amplification+Production Board as shown (see single arrow).

As shown, the Light Amplification+Production Board can also control an LCD Modulator or other frame light modulator, and can control, as shown, a Spillage Unit which might comprise a set of lights, lamps, LEDs, or lasers that are meant for broadcast in a particular way or particular direction, such as shown in prior figures (Spill). In this example, it is also shown that data can flow back from the Light Amplification+Production Board to the Video Content Analysis+Active Frame Light Control Signals unit, such as for the purpose of compiling a history of broadcast ambient light.

FIG. 38 shows a functional schematic diagram for control of an active diffuser frame system according to the invention including using a plurality of active frame inputs, and where ambient conditions and user preferences are utilized. Transfer of control or other signals are shown using solid lines as before, while optical or light transfer is now shown using dashed lines. As before, a functional module, software module, or hardware module is shown, Video Content Analysis+Active Frame Light Control Signals, receiving any or all of six inputs: Passive Sensing of Display Light, Active Video Signal Pickoff, Sensing of Room Conditions (Light and Sound), Frame Touch or Vibration Sensing, User Preferences, and Active Frame Output History, as shown. This module also yields two outputs in this example—one, controlling a Light Amplification+Production module, such as described previously in FIG. 37, and another, shown specifically marked as fiducial area signal FAS. Fiducial area signal FAS is fed to a module, contained in the active diffuser frame system or inside display D to help drive display output pixels that reside in a fiducial area FA (shown Drive Display Output Pixels). This optional process of driving display pixels in display D to produce modified display output light based on one more active frame inputs is described in FIGS. 19, 40 and 41.

The modified display output light K+ thus produced by display D is shown using a dotted line to contribute optically to the Passive Optical Input from Display as shown, in a sort of feedback loop, and naturally, the driving of display output pixels in the fiducial area FA can contribute as shown to providing associated inputs to Passive Sensing of Display Light, and Active Video Signal Pickoff as shown.

Passive optical input from the display can provide light for Passive Optical Rebroadcast as shown, and this light can directly become ambient light sent to an observer Q as shown, and/or the light can contribute to, or be modified by, a Light Amplification+Production module as shown, such as where the passive light is subsequently modified by a frame light modulator AM. The Light Amplification+Production module can provide three optical or light outputs: one, via light sources, not explicitly shown in this FIG. 38, such as using LEDs, as described in FIG. 37; another, as shown, to a functional/physical module such as a photoluminescent emitter PE to provide Fluorescent Boost, Color Gamut Broadening as shown; the third, to a functional/physical module such as a goniophotometric element AN to provide Goniophotometric+Goniochromatic Effects as shown. The output light or ambient light ultimately produced by these modules is shown at the bottom left of this FIG. 38 as directed at or available to an observer Q. Nothing precludes, of course, modulating a goniophotometric element to change the character of light produced thereby, such as a motorized goniophotometric element AN which changes the angle of an internal optic, such as the mounting angle of front face FF in FIG. 30, in response to a signal in an active frame light control signal.

FIG. 39 shows a similar functional schematic diagram for control of an active diffuser frame system according to the invention, similar to that shown in FIG. 38, but which also includes video frame parsing and use of a graphical user interface. As before, the functional module, software module, or hardware module is shown, Video Content Analysis+Active Frame Light Control Signals, can receive any or all of the previously discussed six inputs, as shown. Here, however, a Frame Output Memory, as shown, using known memory device or devices, informs the sixth input, now marked as an Active Frame Output History Table, as shown. The Frame Output Memory in turn obtains information it needs from a monitoring function incorporated into the Video Content Analysis+Active Frame Light Control Signals module, which can be designed and/or programmed to code or otherwise record and output the history of ambient light control it provides.

This history function can be used to alter ambient light (e.g., color buffering or compensation) in response to recent scene light produced by display D, or after a certain color stimulus is seen on active diffuser frame A, or if bright light is momentarily introduced into the ambient space in an otherwise dark home theatre environment. Well known simultaneous color contrast compensation can be effected this way. For example, if a bright white light is projected onto the display (which could be detected by a room condition sensor such as light sensor SL) that is uniformly illuminated with blue light of low intensity, the white light will appear to be a light yellow and the blue light will have a grayer cast than if the two stimuli were presented independently. Essentially, complimentary hues are induced by adjacent illumination or stimuli. This is similar to successive color contrast, such as where a strong color stimulus induces the complementary hue in a subsequent exposure to a stimulus, known as chromatic adaptation. This can be important for home entertainment, and the active diffuser frame system can be used to compensate for an ambient space light event, such as recent bright light, to influence frame color & intensity, and can use the frame output memory to keep a running record of recent color and intensity presented on the display, so as to influence active frame behavior in a favorable way. Thus, a recent video scene involving bright white light followed by a dark scene involving blue light can influence the active diffuser frame system to use a higher saturation blue for a short time during the process of visual accommodation in an observer.

The User Preferences module is now shown to include two inputs: User Preference Values (Memory) which can record and retain user preferences; and Graphical User Interface on Frame Surface as shown, which by its design, will provide coded preferences. In the context of a larger system, graphical user preferences or similar data can be downloaded using from a central server or network, such as a satellite system, into this memory or another active frame system memory.

Light amplification and production (with associated light sources) and passive optical rebroadcast of display light are not shown in this FIG. 39, but it can be seen that the Video Content Analysis+Active Frame Light Control Signals module is now informed by a Video Frame Grabber+Parse Unit and a Content Transformation Unit as shown. The Video Frame Grabber+Parse Unit furnishing some desired characterization of the video display signal RF so as to provide data, probably simplified, to the Content Transformation Unit, as shown, and this can include parsing of individual video frames of the video display signal RF, whether a radio frequency signal, or an MPEG feed. Such parsing can derive a general hue and saturation as an average of the video content, and can incorporate rules for desired effects.

The Content Transformation Unit provides necessary data to the Video Content Analysis+Active Frame Light Control Signals module which allows easy derivation of active frame light control signals for light sources, not shown. This can include any specific color transformations to colors in a color space afforded by use of the light sources. The Content Transformation Unit can employ a Transform Data (Memory) module as shown, to load transformation matrices or the equivalent from read-only memory (ROM) that are needed, as well as any light-source specific or content specific information needed for rendering desired color and character transformation in ambient light produced.

For example, if general or localized edge effects as desired, such as having the edge of distributive frame outer surface AS closest to the display be dimmer, or have light of lower saturation chroma than the outer edge, an appropriate transform can be stored in transform data memory, an can be subject to user preferences. Also, transform data can be used to effect a transfer function that allows for localized light effects, such as bunching together of light from large input areas into particular areas on frame, or pumping light into side areas for projection into the ambient space or for spill onto a backwall.

As mentioned, the active diffuser frame system according to the invention can allow that active frame inputs as described here can be used so that the Video Content Analysis+Active Frame Light Control Signals module generates a fiducial area signal FAS that is used to influence the display D. FIG. 40 shows a video display unit similar to that shown in FIG. 1, but where a fiducial area video signal FAS is provided to the video display unit D to drive fiducial output pixels UF as shown that reside in fiducial area FA. Fiducial output pixels UF normally provide display output light in the fiducial area KF, but after application of the fiducial area signal FAS, the video display signal RF driving the display is supplemented so as to produce modified display light K+ as previously mentioned. This modified display light can be used to increase luminous output of display output light K to strengthen passive display light entering light guide LG. FIG. 41 shows a general schematic showing combining of video frame information to incorporate the original video signal RF with a fiducial area video signal FAS to drive selected fiducial output pixels UF in the video display unit. In the case of an analog waveform, adding fiducial area signal FAS and video display signal RF can be effected using known methods; for digital frames or packets, such as used in the MPEG standards, a processor such as processor CPU or other processor (not shown) can combine or concatenate the signals to drive display pixels U in a desired manner.

In addition to using video information gleaned from display D, the Video Content Analysis+Active Frame Light Control Signals module can analyze the sound provided with video display signal RF and change a character of the ambient light M from active diffuser frame A accordingly according to some desired, scheme—for example, in one mode that might be selected by a user—modulating the overall intensity of the ambient light M as a function of the sound level in the video program content. Thus, FIG. 42 shows a frontal schematic surface view of a display using an active frame A similar to that shown in FIG. 10, where the active frame ambient light M shows a broadcast pattern which can flunctuate and appear to move as a function of time, and in response to video content. For example, a pattern can appear on the frame which performs rotation about the frame in response to a sound pattern, such as a base beat or drum beat, for a concert. The active diffuser frame A shown has a pattern whose sizing and orientation can change as a function of time.

FIG. 43 shows a cartesian plot of relative luminous intensity versus time for an active diffuser frame system which modulates a localized or general ambient light output for itself in response to video content analysis, such as a constituent audio portion of the video content. The undulating luminous intensity variations shown can be in response (not synchronized, as there is no script required to operate the active diffuser frame system) to the audio content of a video signal RF. Alternatively, sound sensor SS as shown in FIG. 35 can sense loud music in the ambient space and start undulating its luminous intensity in response thereto. In either case, a base beat, drum beat, or other generalized or detectible pattern in the video content sound or a similar detectible sound pattern present in the ambient space can be mimicked by the active diffuser frame A, which would appear to participate in the sound pattern, in its own way.

In a similar manner, the sound sensor SS can be used to detect loud voices or sustained high noise levels, and this information can be used by the Video Content Analysis+Active Frame Light Control Signals module to induce a desired effect in the ambient light M produced by active diffuser frame A. For example, loud voices or even laughter can be detected by sound sensor SS along with that provided by the video program content (the native video program content sound can be subtracted out by a subtraction unit not shown in the module circuitry) and this can induce flamboyance or high saturation hues in ambient light M, a fast-rolling or moving pattern in the distributive outer frame AF as shown in FIG. 42, or an undulating luminosity as shown in FIG. 43. A similar flamboyance effect can be triggered result in response to high ambient space light levels detected by light sensor SL. This flamboyance can also include the degree to which fluorescent colors are allowed to be generated by a photoluminescent emitter PE, such as by modulating the use of frame light modulator AM in the embodiment of FIG. 23 to increase or decrease the amount of activation light allowed to impinge upon the photoluminescent emitter.

The graphical user interface described, such as in FIG. 36, can be used to change preferences regarding the system behavior, such as changing the degree of color fidelity desired; changing flamboyance, including the extent to which any fluorescent colors or out-of-gamut colors are broadcast into ambient space; turning the active frame on/off; or changing general intensity levels for active diffuser frame A.

User preferences relating to splashy or flamboyant operation of active diffuser frame A versus subdued, low intensity operation can include the extent to which the active frame is quickly or greatly responsive to changes in video content, such as by exaggerating the intensity or other quality of changes in the video content received and analyzed by the Video Content Analysis+Active Frame Light Control Signals module.

Advanced content analysis can make subdued tones for movies or content of certain character. Video content containing many dark scenes in content can influence behavior of the light source in the active frame, causing a dimming of broadcast ambient light, while flamboyant or bright tones can be used for certain other content, like lots of flesh tone or bright scenes (a sunny beach, a tiger on savannah, etc.).

Generally, the active diffuser frame system can comprise an optional adjunct screen or display of sorts, such as a supplementary display or ambient display, and can use electroluminescent devices for this purpose, which eliminates the need for backlit LCD panels, and allows customized, smaller geometries, such as a 2 centimeter-wide frame that supplements the display D.

The description is given here to enable those of ordinary skill in the art to practice the invention. Many configurations are possible using the instant teachings, and the configurations and arrangements given here are only illustrative, and in particular are simplified for clarity. In practice, an active diffuser frame system according to the invention might appear as part of a larger system, such as an entertainment center or home theatre center.

The teachings given here can be applied to the design and construction of a video display or light transmissive device associated with a video display, incorporating elements and features taught here into same. The front face of a video display, for example, can be made with integral features as taught here. The teachings here can be applied accordingly, so that the active diffuser frame does not have to be an element separate from display D.

Those with ordinary skill in the art will, based on these teachings, be able to modify the apparatus and methods taught and claimed here and thus, for example, morphologically and topologically re-arrange or re-shape components to suit specific applications, and creating components that may bear little resemblance to those chosen for illustrative purposes here.

The invention as disclosed using the above examples may be practiced using only some of the features mentioned above. For example, one can use an LED array or a planar electroluminescent array device as light source LS and also as a distributive outer frame AF, without using any other frame light modulator.

Also, nothing as taught and claimed here shall preclude addition of other structures or functional elements.

Obviously, many modifications and variations of the present invention are possible in light of the above teaching. It is therefore to be understood that, within the scope of the appended claims, the invention may be practiced otherwise than as specifically described or suggested here.

1. An active diffuser frame system (A) for a video display unit (D) to broadcast ambient light into an ambient space, comprising:
a controllable light source (LS, EL, 3EL, D and AM together, LS and AM together, LS and AN together) so sized, positioned, and optically formed as to direct output light from itself to become emitted as at least some of said ambient light (M);
said light source so formed and configured to allow control of said ambient light using at least an active frame input derived from said video display unit, said active frame input selected from the group consisting of:
([a] passive optical input of display output light (K) from said video display unit;
[b] passive sensing of display output light (K) from said video display unit, wherein said active diffuser frame system further comprises a display light sensor (DS) to transduce said display output light from said video display unit for use by said active diffuser frame system, said display light sensor sized, formed and positioned to allow optical communication with said video display unit; and
[c] at least a portion of an active video signal (RF) that drives said video display unit); a distributive outer frame (AF) to mix and distribute said output light into the ambient space.

2. The active diffuser frame system of claim 1, further comprising a processor (CPU) to utilize said active frame input, other than said input [a], to generate a fiducial area video signal (FAS) provided to the video display unit to drive fiducial output pixels (UF) in said video display unit that reside in a fiducial area (FA) to produce modified display light (K+).

3. The active diffuser frame system of claim 1, further comprising a room condition sensor to sense ambient conditions in an ambient space about the video display unit, said room condition sensor selected from the group consisting of [1] a room light sensor (SL), [2] a room sound sensor (SS), and [3] a frame touch sensor (ST), with said frame touch sensor so formed and placed as to be in mechanical communication with said active diffuser frame system;
said active diffuser frame system so further designed to use a signal from said room condition sensor to further control said ambient light.

4. The active diffuser frame system of claim 1, wherein said distributive outer frame comprises an optical device selected from the group of optical devices consisting of: a diffuser, a frame light modulator (AM), and a photoluminescent emitter (PE).

5. The active diffuser frame system of claim 1, further comprising a processor (CPU) so designed and programmed to gather and store user preferences to influence control of said ambient light, and wherein said active diffuser frame system is so configured as to provide a graphical user interface (GUI) upon an exterior surface (AS) of said active diffuser frame system, said graphical user interface so designed to operatively influence said control over said ambient light.

6. The active diffuser frame system of claim 1, further comprising a processor (CPU) so designed and programmed to produce an active frame light control signal to control said light source so that a character of said ambient light is influenced by said active frame input.

7. The active diffuser frame system of claim 6 wherein said processor further comprises a frame output memory and is further programmed to use same to store and utilize a history of said active frame light control signal to further control said light source.

8. The active diffuser frame system of claim 1, wherein said light source comprises a device selected from the group consisting of: [1] an LED (Light Emitting Diode), [2] an electroluminescent device (EL), [3] an incandescent lamp, [4] an ion discharge lamp, [5] a laser, [6] a FED (Field Emission Display), [7] an LCD (Liquid Crystal Display) [8] a frame light modulator (AM), and [9] a photoluminescent emitter;
and further comprises display output light (K) obtained using a light guide (LG) sized, formed and positioned to allow optical communication with said video display unit so as to capture said display output light therefrom.

9. The active diffuser frame system of claim 1, wherein the active diffuser frame is so formed to split, by reflection from a surface (CS), some of the display output light from said video display unit in said active frame input [a] to be redirected (KX), and to allow other display output light to pass substantially outwardly therefrom as imaging light (2).

10. The active diffuser frame system of claim 1, wherein said active diffuser frame system comprises at least one photoluminescent emitter (PE) to provide a spectral modification for said light source so as to color-transform said ambient light emitted from at least a portion of said active diffuser frame system.

11. The active diffuser frame system of claim 10 wherein said photoluminescent emitter is chosen such that said ambient light produced comprises at least one new color (M+) that is outside of a gamut of display output light colors inherently producible by said video display unit unaided by the active diffuser frame system.

12. The active diffuser frame system of claim 1, further comprising a goniophotometric element (AN) so formed and placed with respect to said light source as to provide ambient light which is goniophotometric, that is, changing character as a function of an angle of observation (N, 2) of said active diffuser frame system.

13. The active diffuser frame system of claim 12, wherein said goniophotometric element is so formed as to also be goniochromatic, that is, changing color as a function of an angle of observation (N, 2) of said active diffuser frame system.

14. The active diffuser frame system of claim 12, wherein said goniophotometric element comprises a material selected from the group consisting of: metal flakes, glass flakes, plastic flakes, particulate matter, oil, fish scale essence, thin flakes of guanine, 2-aminohypoxanthine, ground mica, ground glass, ground plastic, pearlescent material, bornite, and peacock ore.

15. An active diffuser frame system (A) for a video display unit (D) to broadcast ambient light (M) into an ambient space, comprising:
a light guide (LG) in optical communication with display output light (K) from said video display unit;
a frame light modulator (AM) in optical communication with said light guide;
said frame light modulator so formed and configured to influence a character of the ambient light using at least the display output light.

16. A method for broadcasting ambient light (M) into an ambient space about a video display unit from an active diffuser frame system, using an active frame input from the video display unit, comprising:
[1] Obtaining an active frame input derived from said video display unit, said active frame input selected from the group consisting of:
([a] passive optical input of display output light (K) from said video display unit, using a light guide (LG) sized, formed and positioned to allow optical communication with said video display unit so as to capture said display output light therefrom;
[b] passive sensing of output light (K) from said video display unit, using a display light sensor (DS) to transduce said output light from said video display unit for use by said active diffuser frame system, and
[c] at least a portion of an active video signal (RF) that controls said video display unit); and
[2] controlling said ambient light using at least said active frame input using a controllable light source (LS, EL, 3EL, D and AM together, LS and AM together, LS and AN together) so sized, positioned, and optically formed as to direct output light from itself to become emitted ambient light (M)
[3] mixing said output light by passage through a distributive outer frame (AF) for distribution into the ambient space.

17. The method of claim 16, additionally comprising color-transforming said ambient light by passing said output light (RGB) from said light source to a photoluminescent emitter (PE) in at least a portion of said active diffuser frame system.

18. The method of claim 16, additionally comprising passing said output light (RGB) from said light source through a goniophotometric element (PN) so formed and placed as to provide said ambient light which is goniophotometric, that is, changing character as a function of an angle of observation (N, 2) of said active diffuser frame system.

19. The method of claim 16, further comprising using a processor in command communication with said light source to influence said control of said ambient light based on factor selected from the group of factors consisting of:
[1] light intensity in the ambient space; [2] sound in the ambient space; [3] touch sensing in the active diffuser frame system; [4] a history of operation of the active diffuser frame system, by storing and using said history in said processor using a memory; and [5] a user preference held in a processor memory.

20. The method of claim 16, further comprising deriving from said active frame input a fiducial area video signal (FAS); and adding information from said fiducial area video signal to a video signal controlling the video display unit so as to drive a plurality of fiducial output pixels (UF) in said video display unit that reside in a fiducial area (FA).
